(19) United States
(12) Patent Application Publication
(10) Pub. No.: US 2005/0264427 A1
(43) Pub. Date: Dec. 1, 2005

(54) Electrical injury protection system

(75) Inventors: Shengke Zeng, Lansdale, PA (US); John R. Powers JR., Morgantown, WV (US); Larry L. Jackson, Morgantown, WV (US); David L. Conover, Bethel, OH (US); Nancy A. Stout, Morgantown, WV (US); Bradley H. Newbraugh, Fairmont, WV (US)

Correspondence Address: KLARQUIST SPARKMAN, LLP, 121 S.W. SALMON STREET, SUITE 1600, PORTLAND, OR, 97204, US

(73) Assignee: The Gov. of the USA as repres. by the Secretary of the Dept. of Health and Human Services

(21) Appl. No.: 11/126,009

(22) Filed: May 9, 2005

Related U.S. Application Data
(63) Continuation-in-part of application No. 10/204,031, filed on Aug. 14, 2002, now Pat. No. 6,897,783.
(60) Provisional application No. 60/186,860, filed on Mar. 3, 2000.

(51) Int. Cl. G08B 21/00

(52) U.S. Cl. 340/635

(57) ABSTRACT

The present disclosure concerns an electrical injury protection system for protecting individuals working on or near a power circuit. In one embodiment, the system comprises a controller that is electrically connected to a power circuit and a detector that is carried by a user working. The detector has three or more electrodes mounted on the user's body which detect the electric field induced on the body by the power circuit. The detector is operable to detect the voltage between each pair of electrodes and activate an alarm if the voltage between any electrode pair exceeds a predetermined proximity threshold. If the voltage between an electrode pair exceeds a predetermined electrical-contact threshold, the detector transmits a tripping signal to the controller to activate a tripping mechanism, which de-energizes the power circuit. In certain embodiments, the controller can be used to monitor the de-energized condition of a de-energized circuit.

### CROSS REFERENCE TO RELATED APPLICATIONS

The present application is a continuation-in-part of U.S. patent application Ser. No. 10/204,031, filed Aug. 14, 2002, which is the National Stage of International Application No. PCT/US01/40181, filed Feb. 23, 2001, which claims the benefit of U.S. Provisional Application No. 60/186,860, filed Mar. 3, 2000. Application Ser. Nos. 10/204,031, PCT/US01/40181, and 60/186,860 are incorporated herein by reference.

### GOVERNMENT INTERESTS

This invention was made by the National Institute for Occupational Safety and Health, Centers for Disease Control and Prevention, an agency of the United States Government.

### FIELD

The present disclosure relates to electrical injury protection systems and methods, and more particularly, to personal electrical protection systems that can provide warnings of potential electrical hazards upon close approach to a power circuit and/or de-energize the power circuit if a user electrically contacts the power circuit.

### BACKGROUND

Electrocution is a serious cause of occupational fatality which ranked fifth among occupational fatalities in the United States from 1980 to 1995 with 6,242 electrocution deaths. NIOSH (1999), National Traumatic Occupational Fatalities (unpublished data), Division of Safety Research, National Institute for Occupational Safety and Health, Morgantown, W. Va. An investigation of 98 occupational electrocution fatalities showed that 54% of the victims were working around an electrical circuit that was not de-energized and 97% of these victims were injured by power circuits which were not equipped with ground fault circuit interrupters. NIOSH (1994), Fatality Assessment and Control Evaluation Database (unpublished data), Division of Safety Research, National Institute for Occupational Safety and Health, Morgantown, W. Va.

Techniques which have been used to prevent such electrocutions include, for example, de-energizing power circuits before working in the area, maintaining appropriate distances from energized circuits, and placing barriers to prevent electrical contact with energized circuits. Oftentimes, however, these methods are not practical, not used properly, or are simply ignored by individuals working with or around electrical power circuits. Accordingly, there remains a need for an electrical protection system for individuals working with or around power circuits which will warn of the potential for electrocution and will, if electrical contact is made with the power circuit, de-energize the power circuit to prevent and/or minimize injury due to electrocution.

### SUMMARY

The present disclosure concerns an electrical injury protection (EIP) system for protecting individuals working on or near a power circuit (e.g., a power line or an electrical circuit). In accordance with one embodiment, the electrical injury protection system includes a worker-worn low-power radio-frequency (RF) body transmitter which transmits an RF signal (generally in the range of 50 kHz to 2 MHz) via a user's body to a controller (also referred to herein as a receiver) that is electrically connected to a power circuit, such as via an electrical receptacle. By employing the specific characteristics of the RF signal transmission between the body transmitter and the power circuit in this frequency range, the system can function as a proximity sensing alarm as well as an electrical contact sensor.

In certain embodiments, the controller has a proximity-dependent alarm or other warning device that is activated when the user approaches the energized power circuit. One example of such an alarm “chirps” or produces sounds at increasing frequency as the user approaches the circuit. The controller preferably has a tripping mechanism that can trip a circuit breaker and/or a ground fault circuit interrupter (GFCI) on the power circuit. If the user electrically contacts the power circuit, the tripping mechanism trips a circuit breaker by causing an artificial line-neutral overcurrent and/or trips a ground fault circuit interrupter (if present) by causing an artificial line-to-ground current (referred to herein as “ground current”), thereby de-energizing the power circuit before serious injury can occur.

Although the embodiments of the personal protection system described herein are mainly designed for use by electricians and construction workers, they may be used by other individuals who work in hazard areas where there is a risk of electrocution. If desired, these systems could also be used by, for example, a home owner working on or near electrical circuits or home electrical systems.

In particular embodiments, the body transmitter has a high frequency signal generator and a lower frequency signal generator. The high frequency signal generator generates high frequency (HF) signals (e.g., about 200 kHz to about 2 MHz) carrying information relating to the user's proximity to the power circuit. The low frequency generator generates low frequency (LF) signals (e.g., about 50 kHz to about 200 kHz) carrying information relating to the user's electrical contact with the power circuit. The HF and LF signals are transmitted through the user's body, the air, the power circuit to the controller. The strength of the HF signals received by the control corresponds to the user's proximity to the power circuit, while the strength of the LF signals indicates whether the user's body is in contact with the power circuit. The controller monitors the HF and LF signals and generates an approach warning feedback signal if the HF signal exceeds a predetermined proximity threshold corresponding to an unsafe location relative to the power circuit. The feedback signal is transmitted back to the body transmitter, which in turn activates an alarm mechanism to warn the user of a close approach to the power circuit. If the LF signal exceeds a predetermined electrical-contact threshold, the controller activates the tripping mechanism to de-energize the power circuit. Alternatively, the body transmitter can include a signal generator that generates an RF signal that carries both proximity and electrical-contact information.

In another embodiment, the electrical injury protection system includes a controller that is electrically connected to a power circuit and a detector, or receiving device, that is mounted on or otherwise carried by the user. The controller includes a signal generator that generates an RF signal (desirably an Ultra High Frequency (UHF) signal) that is transmitted through the power circuit, the air, and the user's body to the detector. If the signal received by the detector exceeds one or more predetermined proximity thresholds, the detector activates an alarm mechanism to provide a proximity warning to the user. This also causes the detector to begin generating a low frequency tripping signal. If the user electrically contacts the power circuit, the LF signal is transmitted to the controller via the user's body and the power circuit and activates a tripping mechanism of the controller, thereby de-energizing the power circuit. In alternative embodiments, other types of wireless communication links can be used to transmit a tripping signal from the detector to the controller. For example, in one implementation, the detector transmits infrared signals to the controller to activate the tripping mechanism when the user contacts the power circuit.

In another embodiment of the electrical injury protection system, a controller is electrically connected to a power circuit and a detector has two or more electrodes mounted on the user's body (e.g., on the chest, arm, or leg). If the user's body contacts the power circuit, the detector detects a voltage on the user's body and transmits a tripping signal to the controller to activate a tripping mechanism, thereby de-energizing the power circuit. The tripping signal can be transmitted via radio waves, infrared signals, or another type of wireless communication link.

In another embodiment, a detector includes two or more electrodes mounted on the user's body which detect the electric field (typically a 50 to 60-Hz electric field) induced on the body by a power circuit. The detector determines the voltage between the electrodes and activates an alarm to provide a proximity warning if the voltage exceeds one or more predetermined proximity thresholds. For example, the alarm can produce a different warning signal each time the detected voltage exceeds a proximity threshold to indicate that the user is moving closer to the power circuit. For electrical contact protection, the detector can be used with a controller that is electrically connected to the power circuit. In this manner, if the voltage exceeds a predetermined electrical-contact threshold, the detector transmits a wireless tripping signal to the controller to activate a tripping mechanism, thereby de-energizing the power circuit.

In particular embodiments, the detector includes at least three electrodes mounted on the user's body. The detector is operable to detect the voltage between each pair of electrodes and activate the alarm if the voltage between any electrode pair exceeds the predetermined proximity threshold. Similarly, the detector transmits a wireless tripping signal to the controller if the voltage between any electrode pair exceeds the predetermined electrical-contact threshold. By employing at least three electrodes, the detector has a greater reliability in detecting the induced electric field on the user's body regardless of the position of the body with respect to the source of the electric field.

In an alternative embodiment, an equipment-mounted detector includes first and second electrode plates which detect the electric field induced on a piece of electrically conductive equipment (e.g., a metal ladder, a boom, a vehicle, etc.) by a power circuit. The first electrode plate is electrically connected to the piece of electrically conductive equipment and the second electrode plate is spaced from and parallel to the first electrode plate. The detector detects the voltage between the electrode plates induced by the electrical field of the power circuit and activates an alarm to provide a proximity warning if the voltage exceeds one or more predetermined proximity thresholds. For electrical contact protection, the detector can be used with a controller that is electrically connected to the power circuit. In this manner, if the voltage exceeds a predetermined electrical-contact threshold, the detector transmits a tripping signal to the controller to activate a tripping mechanism, thereby de-energizing the power circuit.

In another embodiment of the electrical injury protection system, a controller adapted to be electrically connected to a power circuit includes a voltage sensor and a tripping mechanism. The controller in this embodiment is used to monitor the “lock-out/tag-out” (LOTO) condition of a de-energized power circuit, such as if a worker is working on the power circuit or electrical equipment connected to the power circuit. If the power circuit is accidentally re-energized (breaching the LOTO condition), the voltage sensor detects the increase in voltage and activates the tripping mechanism to de-energize the power circuit.

In another embodiment of the electrical injury protection system, a controller is adapted to be electrically connected to a first power circuit and includes an adjacent field voltage sensor and an alarm mechanism. The controller in this embodiment is used to monitor the “lock-out/tag-out” (LOTO) condition of a de-energized adjacent, second power circuit. Specifically, if the second circuit is accidentally re-energized (breaching the LOTO condition of the second circuit), the adjacent field voltage sensor detects the voltage induced on the first power circuit by the second circuit and activates the alarm mechanism to warn personnel of the unsafe condition.

In another embodiment, the electrical injury protection system includes a controller adapted to be electrically connected to a power circuit, a body-mounted detector that can detect a voltage induced on the user's body by the power circuit, and/or an equipment-mounted detector that can detect a voltage induced on a piece of electrically conductive equipment by the power circuit. The controller includes a tripping mechanism, an alarm mechanism, a voltage sensor, an adjacent field voltage sensor, and a signal receiver in communication with the detectors. The controller in this embodiment has two operating modes. In the first operating mode, the controller is used with the body-mounted detector and/or the equipment-mounted detector as a proximity and electrical-contact monitor. In the second operating mode, the voltage sensor and the adjacent field sensor of the controller monitor the “lock-out/tag-out” (LOTO) condition of a de-energized power circuit and a de-energized adjacent power circuit, respectively.

In another representative embodiment, an electrical injury protection system comprises a voltage sensor electrically connected to a first power circuit and operable to detect a voltage induced on the first power circuit by an electric field radiated from an accidentally re-energized second power circuit, and an alarm mechanism that is activated if the voltage detected by the voltage sensor exceeds a predetermined re-energization threshold. The system can further comprise a tripping mechanism that is operable to de-energize the second power circuit if the second power circuit is accidentally re-energized and electrically contacts the first power circuit.

In another representative embodiment, a method for protecting against electrical injury caused by accidental re-energization of a primary power circuit comprises detecting a voltage on the primary power circuit generated by accidental re-energization of the primary power circuit, and automatically tripping a circuit breaker or GFCI on the primary power circuit to de-energize the primary power circuit if the detected voltage exceeds a predetermined re-energization threshold. The method can further comprise activating an alarm mechanism if the detected voltage exceeds the predetermined re-energization threshold to warn personnel of the accidental re-energization. The method can also comprise detecting a voltage induced on the primary power circuit by an electric field radiated from an accidentally re-energized adjacent power circuit, and activating an alarm mechanism if the detected voltage induced by the re-energized adjacent power circuit exceeds a predetermined re-energization threshold to warn personnel of the accidental re-energization. The method also can comprise automatically tripping a circuit breaker or GFCI on the adjacent power circuit if the adjacent power circuit is re-energized and electrically contacts the primary power circuit.

In another representative embodiment, a method of monitoring proximity of an individual relative to an electrical power circuit comprises transmitting a modulated ASK RF signal via the power circuit, detecting the signal at the individual's location relative to the power circuit, digitally demodulating the detected signal, and providing a proximity warning if the demodulated signal exceeds one or more predetermined proximity thresholds. The act of digitally demodulating the detected signal can comprise converting the detected signals into a saw-tooth-like enveloped waveform, demodulating the saw-tooth-like enveloped waveform, and digitizing the demodulated waveform into a square wave having a pulse width corresponding to the amplitude of the detected signal. The transmitted signal can be detected by at least two electrodes mounted on the individual's body. To filter noise from the demodulated square waves, and therefore minimize false alarms, the method can further include the act of rejecting demodulated square waves having a period outside of an acceptable range (for example, the period of the modulated ASK signal±20%). For example, the period of each demodulated square wave can be compared to an acceptable range and rejected if its period is not within the range.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic view of an electrical injury protection (EIP) system, according to one embodiment. This embodiment includes a transmitter 10 attached to the user's wrist and a receiver/controller attached to the power circuit. The transmitter 10 is shown in more detail in the lower right hand corner of FIG. 1.

FIG. 2 is a block diagram of one configuration of the electrical injury protection system shown in FIG. 1, which uses a high frequency signal for proximity sensing, a low frequency signal for electrical-contact sensing, and an approach-warning-feedback radio frequency signal.

FIG. 3 is an operational flowchart of the electrical injury protection system shown in FIG. 2, according to one embodiment.

FIG. 4 shows three graphs of RF power transmitted from a human body transmitter and received at a controller connected to a power circuit versus the distance between a human body and the power circuit. Panel A shows the high RF frequency signal as a function of distance; Panel B shows the low RF frequency signal as a function of distance; and Panel C shows a combined RF signal carrying both proximity and electrical contact information as a function of distance.

FIG. 5 is a block diagram of another embodiment of the electrical injury protection system, in which a combined RF signal is used for both proximity and electrical contact sensing.

FIG. 6 is a block diagram of another embodiment of the electrical injury protection system, in which a detector device mounted on a user monitors RF signals from a controller for proximity and electrical-contact sensing.

FIG. 7 is a block diagram of the detector device shown in FIG. 6, according to one embodiment.

FIGS. 8a-8d are graphs illustrating a method for demodulating and digitizing ASK RF signals, according to one embodiment.

FIG. 9 is a block diagram of yet another embodiment of the electrical injury protection system, which monitors the electrical potential on the user's body to detect electrical contact with a power circuit. One embodiment of an electrical contact sensor used to detect the electrical potential on the user's body is shown in more detail at the bottom of the FIG. 9.

FIG. 10 is a schematic view of another embodiment of the electrical injury protection system, which detects the radiated electric field from a power circuit for proximity and/or electrical contact sensing.

FIG. 11 is a block diagram of the body detector unit and the controller of the system shown in FIG. 10, according to one embodiment.

FIG. 12 is a more detailed block diagram of the body detector unit shown in FIG. 11, according to one embodiment.

FIG. 13 is an operational flowchart of the detector unit shown in FIG. 12.

FIG. 14 is a detailed block diagram of the equipment detector unit of the system shown in FIG. 10.

FIG. 15 is a block diagram of another embodiment of the electrical injury protection system, which can be used for proximity and electrical-contact sensing and for detecting accidental re-energization of a primary power circuit and an adjacent power circuit.

FIG. 16 is a block diagram of an adjacent field sensor of the system shown in FIG. 15 used to detect accidental re-energization of an adjacent power circuit, according to one embodiment.

FIG. 17 is an operational flowchart of the system shown in FIG. 15.

FIG. 18 is a block diagram of another embodiment of the electrical injury protection system, which can be used to detect accidental re-energization of a power circuit.

FIG. 19 is a block diagram of the system of FIG. 18 shown being used to de-energize a primary power circuit upon electrical contact with a re-energized adjacent power circuit.

FIG. 20 is a block diagram of another embodiment of the electrical injury protection system, which can be used to detect accidental re-energization of an adjacent power circuit.

FIG. 21 is a schematic diagram of a tripping mechanism that is used to trip a circuit breaker on a power circuit, according to one embodiment.

FIG. 22 is a schematic diagram of a tripping mechanism that is used to trip a ground fault circuit interrupter (GFCI) on a power circuit, according to one embodiment.

FIG. 23 is a plot showing mean RF transmission loss, during RF transmission from a human body transmitter to a controller (receiver) connected to a power circuit, versus frequency at various distances from a power line.

FIG. 24 is a plot showing mean transmission loss versus distance for selected frequencies based on the same data as shown in FIG. 23.

FIGS. 25a and 25b are screen shots showing saw-tooth-like enveloped ASK signals after passing through an envelope converter for different input ASK signal amplitudes.

FIGS. 26a and 26b are screen shots showing the demodulated and digitized ASK signals of FIGS. 25a and 25b, respectively.

FIG. 27 is a graph showing the pulse width of digitally demodulated ASK RF signals versus the amplitude of their RF inputs.

### DETAILED DESCRIPTION

As used herein, the singular forms “a,” “an,” and “the” refer to one or more than one, unless the context clearly dictates otherwise.

As used herein, the term “includes” means “comprises.”

According to one embodiment, the electrical injury protection (EIP) system comprises a user-worn, low-power radio-frequency (RF) body transmitter which transmits an RF signal (generally in the range of about 50 kHz to about 2 MHz) throughout a user's body and a receiver (also referred to herein as a “receiver/controller” or “controller”) which is plugged into any electrical receptacle or outlet of an energized power circuit or otherwise connected to the energized power circuit in a manner in which, upon actual electrical contact of the user with the energized power circuit, the power circuit is essentially immediately de-energized. As used herein, the term “power circuit” is used generally to refer to a power line (e.g., a high or low voltage overhead power line), an electrical circuit, or electrical equipment that is connected to a power line or an electrical circuit.

The receiver has a proximity-dependent alarm or other warning device that is activated when the user approaches the energized power circuit. One example of an alarm is a proximity-dependent audible alarm which “chirps” or produces sounds at increasing frequency as the user approaches the circuit. If the user makes electrical contact with the power circuit, the receiver preferably has a tripping mechanism that trips a circuit breaker by causing an artificial line-neutral overcurrent and/or trips a ground fault circuit interrupter (if present) by causing an artificial line-ground leakage-current, thereby de-energizing the power circuit before serious injury can occur.

The RF signal transmission used in the electrical injury protection system between the body transmitter and the power circuit is generally in the frequency range of about 50 kHz to about 2 MHz and is largely capacitive-coupling mixed with some RF radiation. The capacitive-coupling ensures that the RF signal received by the receiver varies monotonically versus the proximity of the user to the power circuit. This monotonic RF transmission is appropriate for a proximity dependent alarm as described above, which detects the RF transmission value corresponding to each distance between the user and the power circuit to generate a corresponding alarm signal.

At the lower end of the frequency range, there is little radiation effect. Thus, the RF transmission increases very little as the user approaches the power circuit, but then increases drastically as the user electrically contacts the power circuit. At the higher end of the frequency range, there is more radiation effect than at the lower end. Thus, the RF transmission increases significantly as the user approaches the power circuit, but does not increase drastically as the user electrically contacts the power circuit. In the middle of the frequency range, the RF transmission is generally a mix of those at the higher and lower end of the frequency range. Careful selection of transmission frequency in this embodiment allows the electrical injury protection system to act as a proximity sensing alarm as well as an electrical contact sensor.

The electrical injury protection system in one embodiment has two operating modes. In the first or warning mode, the proximity-dependent alarm is activated as the user approaches an energized power circuit. Since the strength of the received RF signal increases as the user moves closer to the power circuit, the alarm provides a direct proximity dependent warning. For example, using an audible warning device, the frequency or amplitude of the alarm could be increased as the user approaches the energized power circuit. Using a visual warning device, the characteristics of the light (e.g., intensity, color, or pulsing frequency) can be modified to provide a more intense warning as the user approaches the energized power circuit. Of course, other warning devices, or combinations of warning devices, could be used if desired.

The second or electrical-contact mode is activated if the user electrically contacts the energized power circuit in spite of the warnings provided by the alarm. When the user electrically contacts the power circuit, the strength of the transmitted RF signal will increase significantly. The receiver has a tripping mechanism that, when the increased RF signal is detected, trips a circuit breaker on the power circuit and, if present, a ground fault circuit interrupter on the power circuit. More specifically, the receiver recognizes the increase in the RF signal strength as an electrical contact and immediately outputs an excessive overcurrent (between the line and the neutral of the power circuit), which is greater than the current rating of the circuit breaker. This overcurrent immediately trips the circuit breaker, thereby de-energizing the power circuit. Simultaneously, the tripping mechanism also outputs an excessive ground current between the line and the ground of the power circuit to trip the ground fault circuit interrupter on the power circuit. This excessive ground current preferably is sufficient to trip a ground fault circuit interrupter in its minimum reaction time. These two de-energizing actuations work together to ensure that the power to the circuit is turned off as quickly as possible in order to minimize potential electrical shock injury.

In one embodiment, the system comprises a battery-powered transmitting device which can easily be carried or worn by a user (e.g., a worker), an electrode connection which connects the transmitting device to the user's body, a receiver, and a controller electrically connected to a power circuit near a circuit breaker. The receiver can be physically incorporated into the controller or can be a separate component electrically coupled to the controller. In another embodiment, another receiver, such as an alarm, may be provided to receive a feedback signal from the controller. Such a receiver can be physically incorporated into the transmitting device so as to provide a combined transmitting/receiving device or alternatively, the receiver may be a separate component electrically coupled to the transmitting device. In particular embodiments, the controller is plugged into any one of the receptacles on the power circuit, thereby providing protection along the power circuit. The electromagnetic field generated by the transmitting device, the receiving device, and the controller desirably are below the radio frequency exposure safety limit. (See, e.g., IEEE/ANSI Standard C95.1-1999.)

The electrode connectors used to connect the transmitting device or the combined transmitting/receiving device to the body may comprise, for example, at least two electrodes (preferably three or more electrodes) that are attached to the user's body (e.g., on the chest, waist, arms, legs, and the like) or at least two conductive fabric cuffs positioned on, for example, the wrist(s), upper-arm(s), or ankle(s). Desirably, the transmitting device or the combined transmitting/receiving device can be mounted on a belt, tool holster, helmet, or shoe or can fit into a shirt or other pocket of the user. The transmitting device or the combined transmitting/receiving device also can have a low-battery warning light or other alarm. The transmitting device or the combined transmitting/receiving device also can have an “activated” or “armed” warning light or other alarm that can easily be checked by both the user using the system as well as co-users or other personnel to ensure that the device is being used properly.

The electrical injury protection system provides a warning signal to the user when his or her body is within an unsafe distance from a power circuit (e.g., an overhead power line). In addition, the system desirably is capable of detecting any type of electrical contact between the user's body and a low voltage (generally less than about 600 V) electrical power circuit (i.e., line-line, line-neutral, and line-ground), and essentially immediately de-energizes the electrical power source. The reaction or delay time of the system desirably is comparable to, or less than, the duration threshold of ventricular fibrillation (about 13 milliseconds) in order to effectively reduce the risk of ventricular fibrillation and the subsequent death of a user in electrical contact with the power circuit and to reduce the degree of painful sensation that is directly related to the duration of electrical contact.

In certain embodiments, the system is used in combination with a Class A ground fault circuit interrupter (GFCI). Such GFCIs detect circuit-ground electrical contact with a typical reaction time from about 16 to 100 milliseconds depending on the strength of the electrical-contact current (about 16 to 20 milliseconds at 80 mA; and about 35 to 100 milliseconds at 6 mA). By generating an excessive artificial ground current of over 80 mA, the system can trip the GFCI af or close to its minimum reaction time. The system can, however, be adapted to protect users from prolonged electrical shock in a power system without ground fault circuit interrupters.

Certain embodiments of the electrical injury protection device and method disclosed herein utilize radio frequency (RF) signals coupled from a transmitting/receiving device to a human body. In effect, the human body acts as an antenna such that the RF signals can be transmitted from the human body to a power circuit through the air by reactive coupling. RF signal power transmission between the human body and the power circuit can be detected when the body is sufficiently close to the power circuit (generally in the order of several centimeters) to allow for approach indication and/or warning. If there is actual electrical contact between the human body and the power circuit (whether line-line, line-neutral, or line-ground), the RF signal can be directly transmitted from the human body to the controller through the power circuit to activate the controller.

In some embodiments, the personal electrical injury protection system employs high frequency (HF) radio signals carrying information relating to the user's proximity to a power circuit and low frequency (LF) radio signals carrying information relating to the user's electrical contact with the power circuit. An HF signal generator provides HF frequencies close to or at the higher end of a frequency range of 50 kHz to 2 MHz, with an exemplary range for the HF signals being about 200 kHz to about 2 MHz. An LF signal generator provides LF frequencies close to or at the lower end of the frequency range of 50 kHz to 2 MHz, with an exemplary range for the LF signals being about 50 kHz to about 200 kHz. The RF transmission between the user's body and a power circuit in the HF range is mainly capacitive and with more RF radiation than that in the LF range. The RF transmission in the HF range increases monotonically and more gradually than in the LF range as the user approaches the power circuit. Thus, the HF range is suitable to carry proximity information. In contrast, the RF transmission in the LF range increases monotonically and more sharply than in the HF range as the user's body electrically contacts the power circuit, and therefore is better suited to carry electrical-contact information.

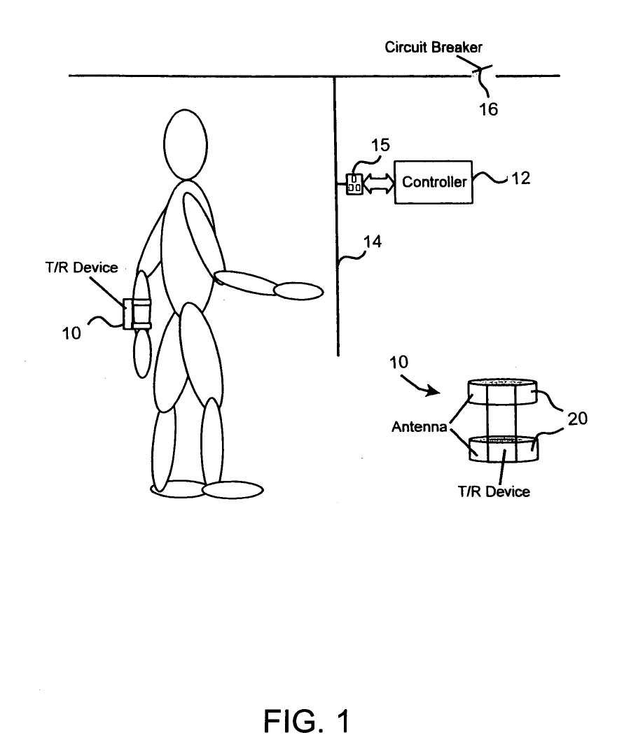

One embodiment of the electrical injury protection system is illustrated in FIG. 1. The illustrated system includes a combined transmitting/receiving device 10 (T/R device) that can be carried or worn by a user, a controller 12 coupled to a power circuit 14 via an electrical outlet 15, and a circuit breaker 16. The power circuit 14 typically is a low voltage (<600 V) residential or construction site power system with a line, neutral, and/or ground wire bundle. The line and neutral wires are, of course, preferably insulated but could have insulation defects. The electrical injury protection system can be used to protect individuals working around unshielded or defective shielded power lines.

The combined transmitting/receiving device 10 is electrically connected to the user's body via electrodes 20 and can be held in place with, for example, straps or other suitable mechanisms. In certain embodiments, the electrodes 20 are conductive fabric cuffs or straps worn around the arm of a user. In operation, the combined transmitting/receiving device 10 communicates with the controller 12 through the following path: (1) the T/R device 10; (2) the user's body acting as an effective antenna; (3) air in case of close approach or directly in case of actual electrical contact; (4) the power circuit 14; and (5) the controller 12. The radio frequency output/input electrodes or conductive fabric cuffs 20 of the T/R device 10 are attached to the user's body (e.g., the user's wrist as shown in FIG. 1) to form a human body-effective transmitting/receiving antenna. The controller 12 has an input and output (not shown) coupled to the power circuit so as to form a power circuit-effective receiving/transmitting antenna.

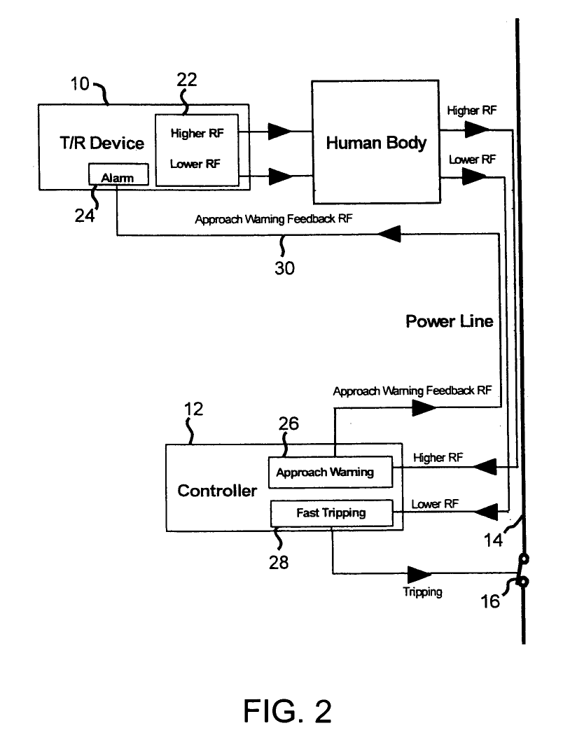

A more detailed system configuration of the embodiment of FIG. 1 is shown in FIG. 2. The T/R device 10 in the illustrated embodiment includes a high frequency (HF) and low frequency (LF) signal generator 22 and an alarm mechanism 24 (also referred to herein as an alarm). In operation, the T/R device 10 generates pulse coded HF signals (e.g., signals in the range of about 200 kHz to about 2 MHz) and LF signals (e.g., signals in the range of about 50 kHz to about 200 kHz), with the magnitude in a preferred range of about 0.5 to about 4 volts (although signals outside of this range can be used), which are transmitted through the human body to the air. The controller 12, which is connected to the power circuit 14, includes an approach warning mechanism 26 and a fast tripping mechanism, or quick tripping mechanism, 28. The approach warning mechanism 26 monitors the HF signal power level of the signal transmitted to the controller 12. If the HF signal level exceeds a specific threshold (i.e., the user moves within an unsafe distance from the power circuit), the approach warning mechanism 26 generates an approach warning RF feedback signal 30, which is transmitted through the power circuit, air, and the user's body to the T/R device 10 to activate the alarm mechanism 24. In lieu or in addition to the alarm mechanism 24 of the T/R device 10, the controller 12 also can be provided with an alarm mechanism.

The tripping mechanism 28 monitors the LF signal from the T/R device 10. If the LF signal level exceeds a predetermined electrical-contact threshold indicative of electrical contact between the user and the power circuit, the tripping mechanism 28 can trip an existing GFCI (not shown) and/or the circuit breaker 16 on the power circuit. If a GFCI is installed on the power circuit, the tripping mechanism artificially causes a strong line-to-ground leakage current (ground current) (desirably greater than about 80 mA) in order to trip the GFCI. Such a current strength is generally sufficient to trip a Class A GFCI in its minimum delay time of about 16 to 20 milliseconds. If a circuit breaker 16 is installed on the power circuit, the tripping mechanism 28 also generates a strong line-to-neutral overcurrent that is greater than the current rating of the circuit breaker in order to trip the circuit breaker within the shortest possible time.

The reaction time of circuit breaker tripping is inversely related to the strength of the line-to-neutral overcurrent. In other words, the greater the strength of the overcurrent, the shorter the reaction time for circuit breaker tripping. Thus, the over current caused by the tripping mechanism 28 desirably is large enough to trip the circuit breaker within the shortest possible time without creating a risk of fire. Desirably, the strength of the over current is that which provides for a short reaction time of about 16 to 20 milliseconds (which is comparable to the minimum delay time of a Class A GFCI). This short reaction time in tripping reduces the user's risk of ventricular fibrillation as well as the degree of painful sensation normally associated with electrical shock. In particular embodiments, both the GFCI and the circuit breaker 16 are tripped in the case of actual electrical contact to provide maximum protection in the shortest possible time. In other embodiments, the tripping mechanism can be configured to trip the CFCI or the circuit breaker, but not both.

For tripping the circuit breaker 16, the tripping mechanism 28 can comprise, for example, a low resistance unit such as a silicon controlled rectifier (SCR) which connects a low resistance resistor between the line and neutral to cause an overcurrent in the power circuit. The overcurrent will immediately trip the circuit breaker 16, thus protecting the user from prolonged electrical shock. Alternatively, as illustrated in FIG. 21, the tripping mechanism 28 can include a triac device 46a having two SCRs 48a, which is suitable for use with AC current. When the tripping mechanism 28 is activated, the triac device 46a connects a resistor 50a between the line and neutral to generate an overcurrent in the power circuit. In one implementation, the triac device 46a electrically connects a 0.5-ohm high power resistor 50a to the line and the neutral for about 20 milliseconds. This generates about 240 amperes of pulsed overcurrent, which trips a typical thermo-magnetic circuit breaker with a current rating of 15-20 amperes in about 17 milliseconds (a typical thermo-magnetic circuit breaker has a tripping threshold of about 210 amperes).

For tripping a GFCI, as illustrated in FIG. 22, the fast tripping mechanism 28 can include a triac device 46b that electrically connects a resistor 50b to the line and ground of the power circuit to generate an artificial ground current. In one implementation, the triac device 46b electrically connects a 600-ohm high power resistor 50b to the line and the ground for about 30 milliseconds. This generates about 0.2 amperes of pulsed ground-current, which trips a typical GFCI with a current rating of 15-20 amperes in about 16-20 milliseconds (a typical GFCI has a tripping threshold of about 0.06-0.08 amperes).

If a circuit breaker 16 and a GFCI are installed on the power circuit 14, the tripping mechanism 28 can include a triac device 46a and a resistor 50a (FIG. 21) for generating an artificial overcurrent for tripping the circuit breaker and a triac device 46b and a resistor 50b for generating an artificial ground current for tripping the CGFI.

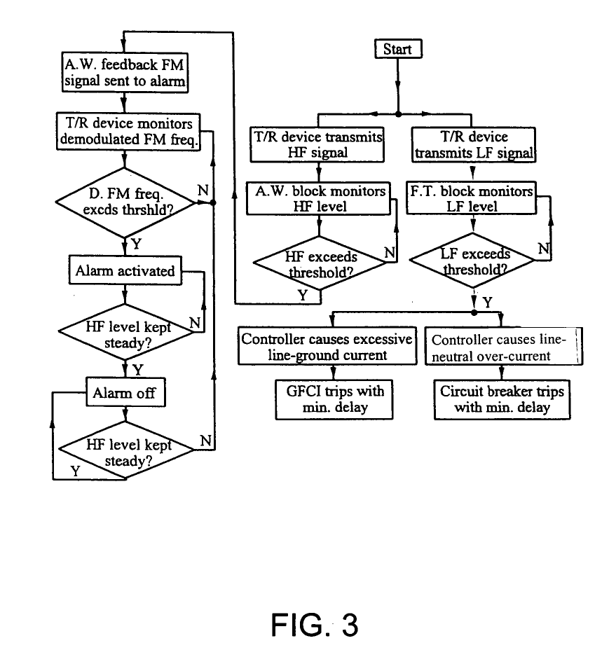

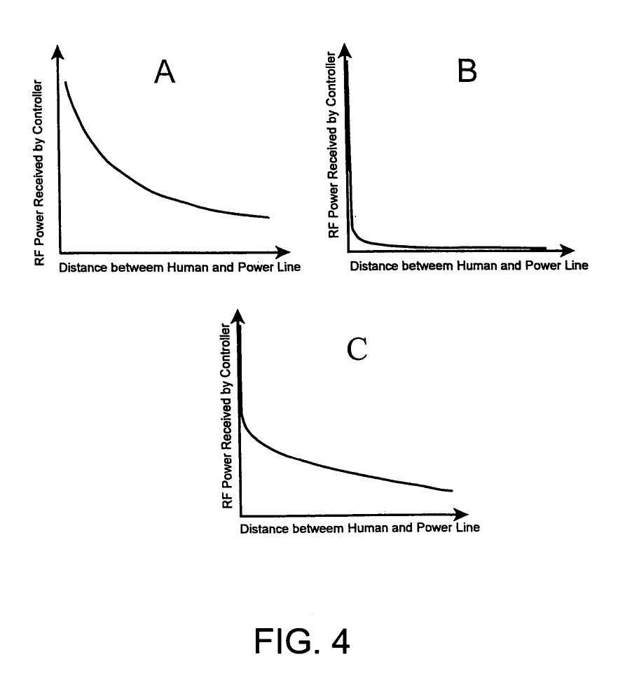

FIG. 3 is an operating flow chart of the system shown in FIG. 2, according to one embodiment. In operation, the T/R device 10 transmits a low power coded HF signal through the user's body into the air. If the user is too close to the power circuit 14, an appropriate amount of HF signals is coupled to the power circuit and is received by the controller 12 through the following pathway: the T/R device 10 to the user's body to the air to the power circuit 14, and finally, to the controller 12. The HF power on the power circuit 14 is directly related to the proximity of the user's body (see FIG. 4A). If the power of the HF signal received by the controller exceeds a specific predetermined threshold, this HF signal activates the approach warning mechanism 26, which in turn transmits a frequency-modulated (FM) feedback signal via the following pathway: the controller 12 to the power circuit 14 to the air to the user's body, and finally, to the T/R device 10.

The modulation frequency of the FM signal is directly related to the proximity of the user's body to the power circuit 14 (i.e., the closer the body is to the power circuit, the higher the modulation frequency). The T/R device 10 demodulates the feedback FM signal and monitors the demodulated frequency. If the demodulated FM frequency is greater than one or more predetermined proximity thresholds, the alarm mechanism 24 is activated and a warning signal is generated to warn the user that he or she is too close to a live wire.

Desirably, although not necessarily, the alarm mechanism 24 employs an audible chirp signal whereby the frequency of the chirping conveys additional warning information. For example, using such a variable chirp signal, the alarm mechanism 24 can increase the pitch of the audible chirp signal as the frequency of the demodulated FM signal increases. The T/R device 10 can also monitor the steadiness of the demodulated FM frequency. If the demodulated FM frequency is temporarily substantially constant (e.g., for about 2 seconds), the alarm mechanism 24 recognizes that the user is holding an electrical tool (which can also cause a higher level HF signal received by the controller) and is de-activated. If the demodulated FM frequency becomes unsteady, the T/R device 10 then re-activates the alarm mechanism if the demodulated FM frequency is still greater than the proximity threshold (indicating that the user is still too close to the power circuit 14).

For electrical contact protection, the T/R device 10 transmits a low power coded LF signal to the controller 12 via the following pathway: the T/R device 10 to the user's body to the air to the power circuit 14, and finally, to the controller 12. If there is no electrical contact between the user's body and the power circuit, the LF signal level received by the controller 12 is too low to activate the controller to de-energize the power circuit 14. If there is electrical contact between the user's body and the power circuit, the following pathway is formed: the T/R device 10 to the user's body to the power circuit 14 via the point of electrical contact, and finally to the controller 12. In such a case, an appropriate amount of the LF signal is received by the controller via the direct electrical contact between the user's body and the power circuit.

A curve of LF power at the controller versus body distance is shown in FIG. 4B. The controller 12 is immediately activated by the LF signal upon electrical contact to de-energize the power circuit 14 by tripping a GFCI and/or a circuit breaker on the power circuit. The controller 12 can be plugged into any receptacle on the power circuit 14 without contacting any circuit breaker or GFCI. The tripping mechanism 28 in particular embodiments can trip an existing GFCI in its minimum reaction time of about 16 to 20 milliseconds regardless of the strength of the electrical-contact AC current. The tripping mechanism 28 trips the circuit breaker with a similar reaction time to that of a class A GFCI. The circuit breaker tripping reaction time can be adjusted by varying the strength of the line-neutral overcurrent. The greater the overcurrent, the shorter the circuit breaker tripping reaction time. This short reaction time can significantly reduce the user's risk of ventricular fibrillation as well as the degree of the painful sensation caused by electrical shock. This system configuration keeps the RF interference on the power system to a minimum, as there are RF signals on the power circuit only when the user approaches the power circuit.

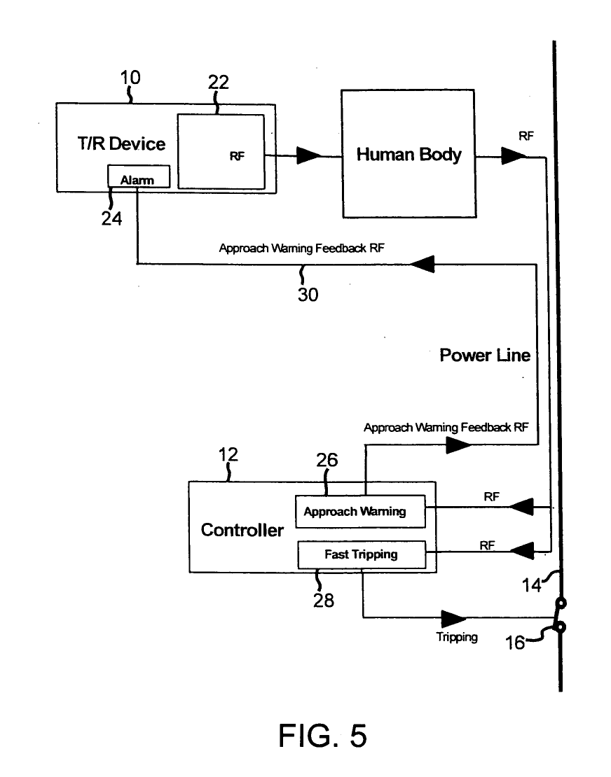

As shown in FIG. 4C, there exist some frequencies between the HF and LF range such that the RF power strength pattern at the controller 12 versus the distance is a combination of the pattern in FIG. 4A and the pattern in FIG. 4B. Based on the RF power distribution shown in FIG. 4C, an alternative system configuration can be used as shown in FIG. 5 where one signal carries both proximity and electrical contact information. Accordingly, in one embodiment, the T/R device 10 transmits only one RF signal that carries both the body proximity and electrical-contact information. An exemplary frequency range for this system is between about 100 kHz and about 1 MHz. At the controller 12, the approach warning mechanism 26 and the tripping mechanism 28 analyze the received combined-RF signal and extract proximity and electrical-contact information from the signal, respectively.

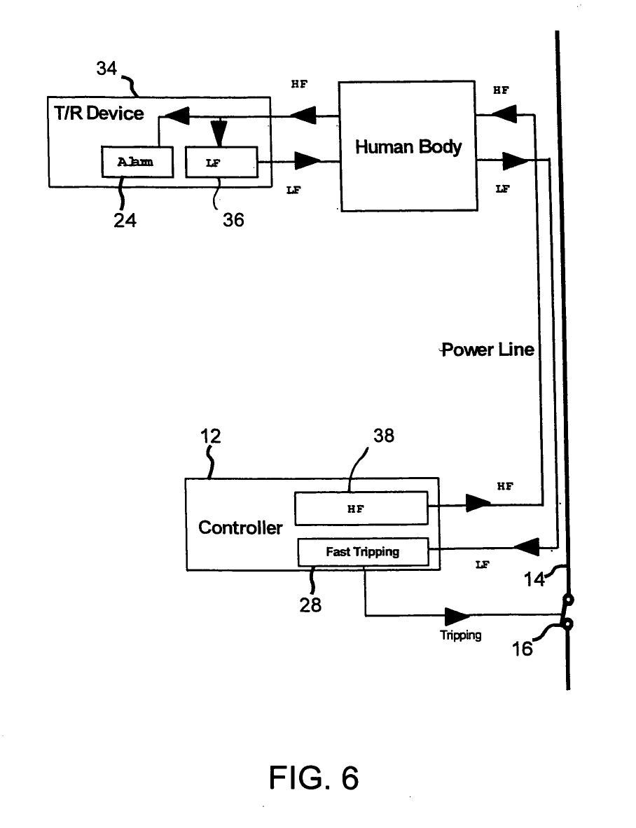

Another alternative embodiment of the personal electrical injury protection system is shown in FIG. 6. The system of FIG. 6 includes a detector device 34 (also referred to herein as a T/R device in embodiments where the device transmits and receives signals) and a controller 12 that is electrically connected to a power circuit 14, such as via an electrical outlet. The detector device 34 can include electrodes 20 (FIG. 1) worn on the arm (or other body portion) of the user for receiving and/or transmitting signals via the user's body and an alarm mechanism 24.

For delivering a body approach warning signal, the controller 12 includes a signal generator 38 that transmits an HF pulse-coded signal (e.g., UHF or VHF signals) through the power circuit 14 into the air. UHF signals typically are in the range of about 300 MHz to 3,000 MHz; VHF signals typically are in the range of about 30 MHz to 300 MHz. If the user is proximate the power circuit, an appropriate amount of the HF signal is detected by the user's body (serving as an antenna) and is coupled to the detector device 34 through the following pathway: the controller 12 to the power circuit 14 to the air to the user's body, and finally to the detector device 34. The HF power on the user's body is directly related to the proximity of the user to the power circuit. If the HF power exceeds one or more predetermined proximity levels, the detector device 34 activates the alarm mechanism 24 to generate a corresponding warning signal (e.g., an audible and/or visual warning signal) to warn the user that he is moving closer to the power circuit. For example, the alarm mechanism can produce a louder alarm signal each time the HF power exceeds a proximity level. Preferably, although not necessarily, the warning signal is an audible signal that varies in pitch, and/or a visual signal that varies in number or color of illuminated lights, as the user moves closer to the power circuit 14.

This excessive HF signal also activates a signal generator 36 of the detector device 34 to transmit a pulse-coded tripping signal via the user's body. The signal generator 36 can be an LF signal generator that generates an LF tripping signal as shown. Alternatively, the tripping signal can be an HF signal (e.g., ultra high frequency (UHF) signals or very high frequency (VHF) signals) or an RF signal of any suitable frequency. If there is no electrical contact between the user's body and the power circuit 14, no significant amount of LF power can reach the power circuit (see FIG. 4B). If there is electrical contact between the user's body and the power circuit, an appropriate amount of the LF power arrives at the controller 12 through the following pathway: the detector device 34 to the user's body to the power circuit 14 via the point of electrical contact, and finally to the controller 12. This LF signal activates the tripping mechanism 28 of controller 12 to immediately de-energize the circuit power. A significant advantage of this alternative system is that the user is only exposed to RF signals when in close proximity to the power circuit, and therefore substantially reduces the RF exposure of the user. The frequency, bandwidth, and the modulation of the HF signal is selected to minimize RF interference with other electrical appliances or equipment connected to the same power circuit to a negligible level.

While in the system shown in FIG. 6 a tripping signal is transmitted to the controller 12 via radio waves, this is not a requirement. Accordingly, other wireless communication links can be implemented to transmit a tripping signal to the controller 12 upon electrical contact with the power circuit. For example, the tripping signal can be transmitted via infrared signals, Bluetooth technology, or various other techniques.

In an alternative embodiment, the system shown in FIG. 6 can be used solely as a proximity detector. In this alternative embodiment, the tripping mechanism 28 and the signal generator 36 would not be required.

In a specific embodiment of the system shown in FIG. 6, the RF signals from the signal generator 38 are modulated using amplitude-shift-keying (ASK). The detector device 34 continuously measures the magnitude of the incoming ASK waves (which is inversely related to the proximity of the user to the power circuit) for proximity and electrical-contact detection. The detector device 34 is battery powered and preferably has a relatively low current consumption (e.g., about 1-2 milliamps) since the device is operated in a continuously-on mode.

To convert the received RF signal to a related range of human proximity to the power circuit 14, the detector device 34 digitally measures the magnitude of the incoming RF signal, and outputs the numerical RF magnitude to a micro-processor. Conventional methods for digitally measuring ASK RF signal magnitude involves demodulating the analog envelopes from an ASK RF signal and then using an analog-to-digital converter (ADC) to convert the analog amplitude of the demodulated envelopes to digits. This method requires an analog envelope demodulator, which consumes much more current (about 15 mA) than the desired consumption limit of the detector device 34. Further, this method requires an ADC for analog-to-digital conversion which also consumes extra battery current (about 0.1-0.6 mA).

To reduce current consumption and to minimize sudden signal fluctuation caused by interference signals, a method for measuring the magnitude of incoming ASK signals involves demodulating the variable magnitudes of the incoming ASK signals to square waves with variable pulse width. Human proximity to the power circuit 14 can be determined by digitally measuring the pulse widths of the demodulated square waves. Such a method allows use of a digital ASK demodulator, which consumes substantially less power than an analog ASK demodulator used in conventional measuring techniques. Additionally, such a method does not require use of an ADC, which further reduces power consumption of the detector device 34.

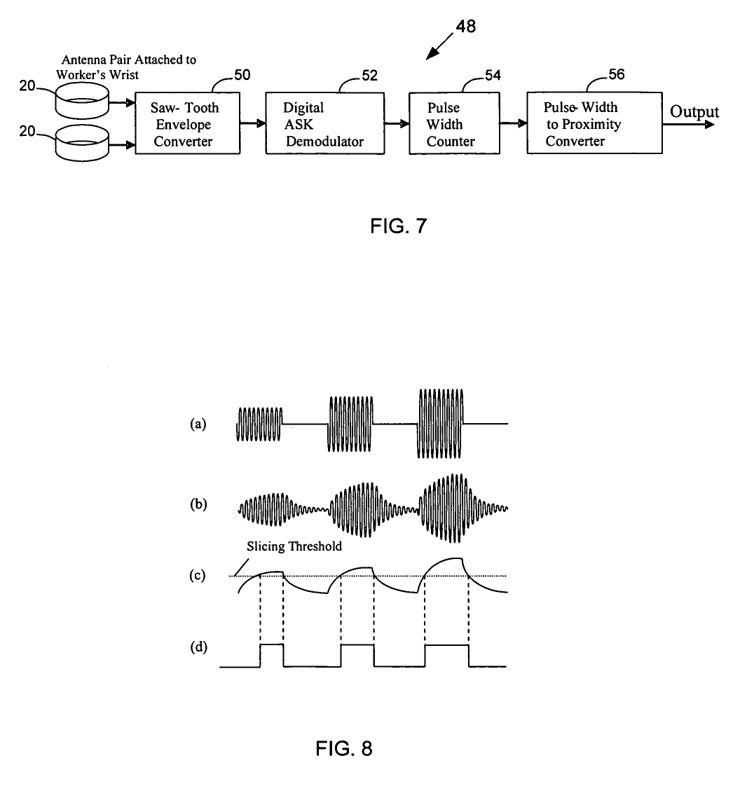

To such ends, and referring to FIG. 7, the detector device 34 in the illustrated configuration includes an ASK receiver 48 comprising an envelope converter 50 that receives input signals from electrodes 20, a digital ASK demodulator 52, a pulse-width counter 54, and a pulse-width to proximity converter 56. In use, the controller 12 (FIG. 6) continuously transmits ASK RF waves through the power circuit 14 to the air. The carrier frequency of the ASK signal is modulated by, for example, a 1 kHz square wave, as depicted in FIG. 8a. As the user moves within a proximity detection range surrounding the power circuit 14, the electrodes 20 (functioning as an antenna for the receiver 48) detect incoming ASK RF signals transmitted through the user's body.

A conventional digital ASK demodulator demodulates ASK envelopes as a stream of square waves which contains no magnitude information. To address this problem, the envelope converter 50 is applied before the input of ASK signals to the digital ASK demodulator 52. The envelope converter 50 converts the incoming square-wave enveloped ASK RF waveforms (FIG. 8a) to saw-tooth-like enveloped ASK waveforms that can be digitized into square waves having pulse widths corresponding to the magnitude of the incoming ASK waves, while keeping the demodulated square-wave frequency the same as the modulating square-wave frequency that is generated by the ASK transmitter in the controller.

In particular embodiments, the envelope converter 50 comprises an impedance inverter and an LC band-pass filter with a narrow pass-band. The impedance inverter matches the relatively lower impedance of human skin with the higher input impedance of the digital ASK demodulator. The band-pass filter filters out noise and other interference frequencies. With its narrow pass-band, the group delay of the filter is nonlinear and therefore distorts the envelope of the incoming ASK RF wave and converts the square-wave enveloped ASK RF signal (FIG. 8a) to ASK RF signals with sloped leading and trailing envelope edges. The bandwidth of the filter is selected so that the filtered ASK envelopes have their leading and trailing edges shaped similar to a saw-tooth wave (as shown in FIG. 8b).

The digital ASK demodulator 52 demodulates the saw-tooth-like envelopes (as shown in FIG. 8c), and digitizes the demodulated envelopes into square waves with their pulse width directly related to the magnitude of the incoming RF signal (as shown in FIG. 8d). More specifically, a fixed slicing threshold (FIG. 8c) digitizes the envelopes into square waves having pulse widths equal to the portions of the envelopes above the threshold. Hence, a saw-tooth-like envelope with a greater magnitude is digitized to a square wave with a wider pulse width, and a saw-tooth-like envelope with a smaller magnitude to a square wave with a narrower pulse width. In alternative embodiments, the demodulator 52 can employ an adaptive slicing threshold that is derived from the average of the input envelope amplitude.

The pulse-width counter 54 receives the demodulated square waves and counts, or measures, their pulse widths, which correspond to the user's proximity relative to the power circuit 14. The pulse-width to proximity converter 56 converts the pulse widths to a proximity range relative to the power circuit 14 (e.g., Far, Medium, Near, or Electrical Contact) by using an empirical conversion algorithm. If the converter 56 determines that user is near the power circuit, an output signal is sent to the alarm mechanism 24 (FIG. 6) to provide a proximity warning. If the user electrically contacts the power circuit, the signal generator 36 sends a tripping signal to the tripping mechanism to de-energize the power circuit. In certain embodiments, the pulse-width counter 54 and the pulse-width to proximity converter 56 are implemented as software executed by a micro-processor housed in the detector device 34.

Notably, the receiver 48 uses a digital ASK demodulator rather than an analog ASK demodulator and does not require an ADC. Hence, the overall power consumption of the receiver is much less than that of a conventional demodulator and therefore is ideally suited (but not required) for use in a battery-powered device operated in a continuously-on mode.

In particular embodiments, in order to increase detector immunity to interference signals, the pulse-width counter 54 also counts or measures the period or frequency of the demodulated square waves. If an interference signal causes the ASK signal to fluctuate and changes the duration of individual periods of the demodulated square waves, the pulse-width counter 54 detects the periods with irregular period durations, and rejects these periods as noise. For example, the periods of the demodulated square waves are compared to an acceptable range encompassing the period of the modulated signal (this range can be, for example, the period of the modulated signal±20%), and any waves falling outside the acceptable range are rejected as noise and are not used to determine the user's location relative to the power circuit. For example, if the frequency of the ASK signal is 1 kHz, the period range for acceptable demodulated square waves can be 1 mS±20%. This ability to reject noise effectively increases the detector noise immunity, and therefore minimizes the possibility of a false alarm.

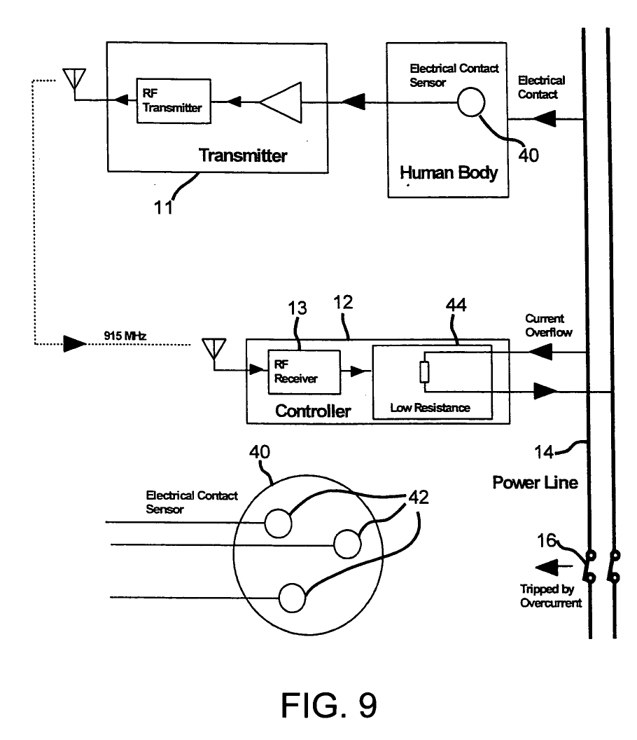

Another alternative embodiment of the electrical injury protection system is shown in FIG. 9. In this embodiment, an RF receiver component 13 is located within the controller 12. This alternative system is expected to be more reliable in detecting an electrical contact and is suitable for protecting, for example, electricians, construction users, and others working near power circuits that are not equipped with ground fault protection. The illustrated system comprises an electrical contact sensor 40 that is attached to a user's body, an RF transmitter 11 carried by the user, and a controller 12 that is plugged into any receptacle along the power circuit 14.

In the specific embodiment shown in FIG. 9, the electrical contact sensor 40 comprises three electrodes 42 that are attached to the user's chest to detect the body electrical potential difference between any two of electrodes 42. Of course, a different number of electrodes as well as different locations on the body can be used. If there is any electrical current flow through the user's chest, there will be a potential difference between at least two of the three electrodes. If the potential difference exceeds a predetermined threshold, the RF transmitter 11 is activated and immediately transmits a coded RF signal train through the air to an RF receiver 13 of the controller 12. The RF frequency desirably is in the VHF or UHF Industrial Scientific and Medical (ISM) bands (e.g., about 915 MHz±13 MHz).

When the controller 12 decodes the coded RF signal train, it immediately activates a tripping mechanism 44 to cause an overcurrent in the power circuit 14. The tripping mechanism 44 may comprise, for example, a low resistance unit such as a silicon controlled rectifier (SCR) which connects a low resistance resistor 50 between the line and neutral to cause an overcurrent in the power circuit. In an alternative embodiment, the tripping mechanism 44 comprises a triac device 46a having two SCRs 48a for use with AC current (as shown in FIG. 21). In either case, the overcurrent will immediately trip the circuit breaker 16, thus protecting the user from prolonged electrical shock. The system offers a significant advantage in that it can protect users from prolonged electrical shock even without the existence of a GFCI.

The tripping reaction time is dependent on the tripping reaction time of the circuit breaker on the power circuit. As mentioned above, the reaction time of circuit breaker tripping is inversely related to the strength of the line-to-neutral overcurrent such that increasing the strength of the overcurrent decreases the reaction time. Thus, the actual reaction time of the circuit breaker is determined by the strength of the generated overcurrent. The controller and the tripping mechanism 44 desirably are configured to reduce the risk of fire caused by the overcurrent, such as by selecting a resistor that has an energy rating greater than the heat energy generated during tripping.

The system shown in FIG. 9 can also be used in power systems protected by GFCIs. In addition to generating an artificial line-to-neutral overcurrent, the tripping mechanism 44 of the controller 12 can generate an artificial ground current (desirably greater than 80 mA) to activate a triac device 46b, which connects a resistor 50b between line and ground upon receiving the electrical contact signal (as shown in FIG. 22). The strength of the ground current desirably is sufficient to trip the GFCI within its minimum reaction time (about 16-20 milliseconds).

In other embodiments, the system shown in FIG. 9 can be used as a proximity detector. In one implementation, for example, the sensor 40 is used to detect a voltage induced on the user's body by the electric field of the power circuit 14. If the detected voltage exceeds a predetermined proximity threshold, an alarm mechanism is activated to warn the user of a close approach to the power circuit.

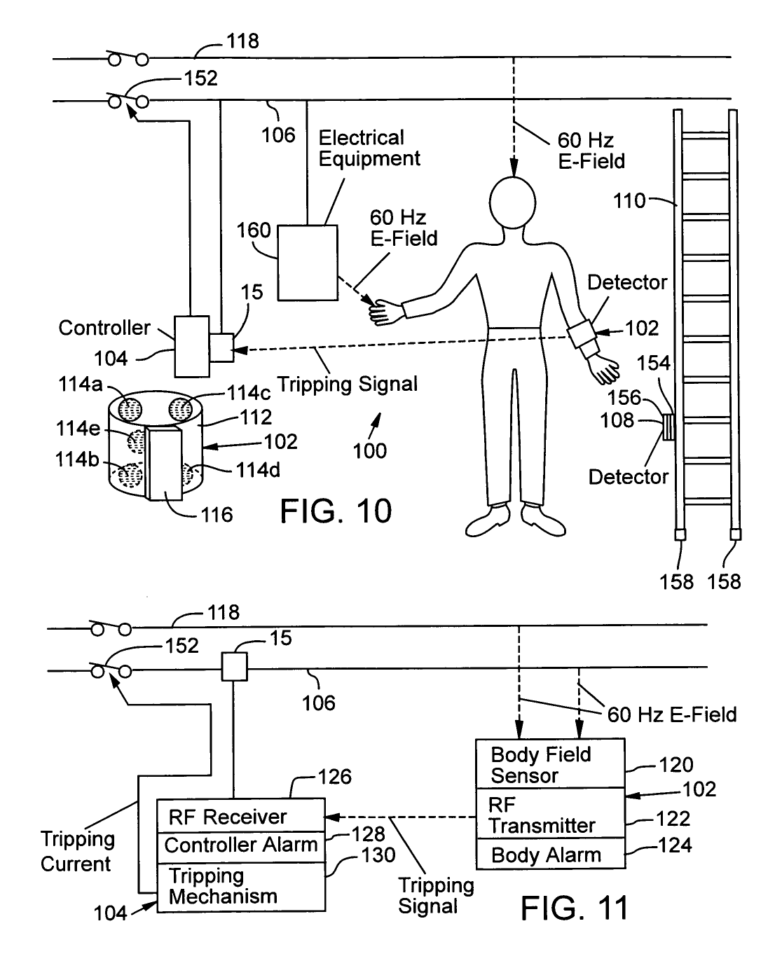

FIG. 10 illustrates an electrical injury protection system 100, according to another embodiment. The system 100 includes a body-mounted detector unit 102 and a controller 104 that is electrically connected to a power circuit 106 (e.g., a high-voltage power line (e.g., at least 600 volts) or a low-voltage power line (e.g., less than 600 volts)). An equipment-mounted detector unit 108 mounted on a piece of electrically equipment, such as the illustrated ladder 110 also can be used. One or both of the detector units 102 and 108 can be used by a user working near the power circuit 106. The controller 104 can be configured to connect to the power circuit 106 via a conventional electrical outlet 15 on the power circuit 106. The detector units 102, 108 are in communication with the controller 104 via a respective wireless communication link, such as by using radio waves (e.g., UHF or VHF radio waves), infrared signals, Bluetooth technology, and the like to transmit proximity and/or electrical contact information to the controller 104, as further described below.

The detector unit 102 (also referred to herein as a detector device) detects the induced electrical field on the user's body caused by the electrical field (typically a 60-Hz electrical field) radiated from the power circuit 106, any electrical equipment 160 on the power circuit 106, and/or an adjacent power circuit 118. The illustrated detector unit 102 includes a mounting device, such as a wrist band 112, for mounting the detector unit on the wrist of the user. In other embodiments, the detector unit 102 can be mounted on the upper arm, leg, or another body portion of the user. The wrist band 112 mounts a plurality of electrodes 114a-114f that are electrically connected to the user's body, such as by placing the electrodes in contact with the user's skin. The electrodes 114a-114f desirably are distributed on the wrist band 112 such that they do not lie in a single plane. This distribution of the electrodes ensures that an electric field on the user's body can be detected regardless of the orientation of the user's arm with respect to the source of the radiated electric field.

While the illustrated embodiment includes a total of six electrodes 114, a greater or fewer number of electrodes 114 can be used. In particular embodiments, at least three such electrodes 114 are used. Although less desirable, in other embodiments, the detector unit 102 can include two electrodes 114.

A housing 116 of the detector unit 102 houses a field sensor 120, a radio frequency (RF) transmitter 122, and an alarm mechanism 124 (FIG. 11). The controller 104 includes an RF receiver 126, an alarm mechanism 128, and a tripping mechanism 130 (FIG. 11). In use, the detector unit 102 senses a voltage between each pair of electrodes 114. If the voltage between any pair of electrodes exceeds one or more predetermined proximity thresholds, the detector unit 102 activates the alarm mechanism 124 to warn the user of a close approach to the power circuit 106 and any adjacent power circuit 118. In addition, the RF transmitter 122 can be used to transmit a signal to the controller 104 to activate the alarm mechanism 128 to warn of the close approach to the power circuit. If the user contacts the power circuit 106, the RF transmitter 122 transmits a tripping signal to the RF receiver 126 of the controller 104, which activates the tripping mechanism 130 to de-energize the power circuit 106. The tipping mechanism 130 can be configured to trip a circuit breaker 152 or a CFCI (not shown) to de-energize the power circuit 106, as described above in regards to the embodiments shown in FIGS. 1-3 and 5-9.

The tripping mechanism 130 can include a triac device 48a and a resistor 50a (FIG. 21) that are operable to generate an artificial overcurrent for tripping the circuit breaker or a triac device 48b and a resistor 50b (FIG. 22) that are operable to generate an artificial ground current for tripping the GFCI.

The warning signal produced by the alarm mechanism 124 can be an audible or visual in nature and can vary depending on the proximity to the power circuit 106. For example, as described above, the alarm mechanism 124 can produce an audible “chirp” that increases in pitch, and/or can produce a visual signal that varies the number and/or color of illuminated lights as the user moves closer to the power circuit. Upon electrical contact with the power circuit 106, the alarm mechanism 124 of the detector unit 102 and/or the alarm mechanism 128 of the controller 104 can be activated to warn other personnel in the area of the condition. The warning signal produced by either alarm mechanism 124, 128 upon electrical contact desirably is different than the proximity warning signal produced to warn of a close approach to the power circuit. In one implementation, for example, the alarm mechanism 124 produces a first audible and/or visual warning signal to warn of a close approach to the power circuit. Upon electrical contact, the alarm mechanism 124 and/or the alarm mechanism 128 produces a second audible warning signal that is louder or greater in pitch than the first warning signal, and/or second visual warning signal with a greater number of illuminated lights or having different color lights than the first visual warning signal.

The frequency of the tripping signal desirably is in the VHF or UHF Industrial Scientific and Medical (ISM) bands (e.g., about 915 MHz±13 MHz), although other frequencies can be used. In alternative embodiments, other types of wireless communication devices can be used to transmit information from the detector unit 102 to the controller 104.

Notably, because the detector unit 102 monitors the electric field induced on the user's body, it provides a warning signal if any portion of the user's body moves within an unsafe distance from the power circuit. In addition, if the user is holding or using a piece of electrically conductive equipment, the detector unit 102 will detect the electric field on the equipment. In this manner, the detector unit 102 can provide a proximity warning if the equipment moves within an unsafe distance from the power circuit, and if necessary, de-energize the power circuit if the equipment electrically contacts the power circuit.

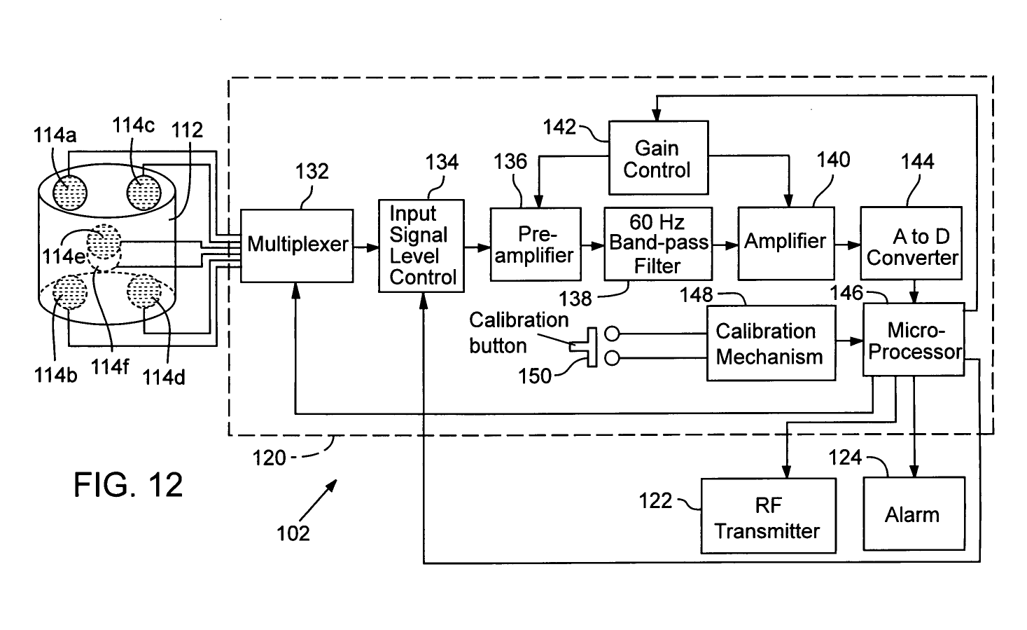

FIG. 12 shows a more detailed block diagram of the field sensor 120 of the detector unit 102, according to one embodiment. As shown in FIG. 12, the field sensor 120 includes a multiplexer 132 that receives input signals from the electrodes 114a-114f, an input signal level control 134 (e.g., a digital potentiometer), a preamplifier 136, a band-pass filter 138, an amplifier 140, a gain control 142, an analog-to-digital (A-D) converter 144, a micro-processor 146, a calibration mechanism 148, and a calibration button 150.

In use, the micro-processor 146 controls the multiplexer 132 to select inputs from a pair of electrodes 114 and provide an output signal representative of the induced voltage between the selected electrodes. The micro-processor 146 controls the input signal level control 134 to attenuate the output signal to a suitable level for the preamplifier. The input signal level control 134 initially is set to attenuate a signal from a high-voltage power circuit (e.g., greater than 600 volts) and gradually increases the signal strength until it can be detected by the micro-processor.

The preamplifier 136 amplifies the output signal to a suitable level for the band-pass filter 138. The band-pass filter 138 (e.g., a 60-Hz filter in the illustrated embodiment) filters out noise and other interfering frequencies. The amplifier 140 receives the signal from the filter 138 and outputs an amplified signal to the A-D converter 144, which outputs a digitized signal to the micro-processor 146 for further signal processing. The micro-processor 146 also controls the gain control 142 to adjust the gains of the preamplifier 136 and the amplifier 140.

The micro-processor 146 compares the voltage between the selected electrode pair to a predetermined proximity threshold and a predetermined electrical-contact threshold. If the voltage exceeds the predetermined proximity threshold, the micro-processor 146 sends a signal to activate the alarm mechanism 124 to warn the user of the close approach to the power circuit 106. If the voltage exceeds the predetermined electrical-contact threshold, the micro-processor 146 controls the RF transmitter 122 to send a tripping signal to the controller 104 (FIGS. 10 and 11) to de-energize the power circuit 106. If the voltage does not exceed either of these thresholds, the process is repeated for another pair of electrodes. Since there are six electrodes in the illustrated embodiment, a voltage can be detected between a total of 30 different electrode pairs. This increases the reliability of the detector device to detect the induced electric field on the body, regardless of the orientation of the arm on which the electrodes are mounted relative to the source of the electric field.

In particular embodiments, the micro-processor 146 also calculates the time derivative of the detected voltage and compares this value to a time-derivative proximity threshold and a time-derivative electrical-contact threshold. The time-derivative proximity threshold and the time-derivative electrical-contact threshold can be determined by calculating the time derivatives of the predetermined proximity and electrical-contact thresholds based on the expected average rate at which the user moves toward the power circuit 106. If either the detected voltage or its derivative exceeds the proximity threshold or the time-derivative proximity threshold, respectively, the micro-processor 146 sends a signal to activate the alarm mechanism 124 to warn the user of the close approach to the power circuit 106. Similarly, if either the detected voltage or its derivative exceeds the electrical-contact threshold or the time-derivative electrical-contact threshold, respectively, the micro-processor 146 controls the RF transmitter 122 to send a tripping signal to the controller 104 (FIGS. 10 and 11) to de-energize the power circuit 106.

The calibration mechanism 148 allows a user to set the predetermined proximity threshold. In use, the user stands at a desired safe distance from the power circuit 106 and presses a calibration button 150. The calibration mechanism 148 detects the strength of the electric field at that location and outputs a signal to the micro-processor 146. The micro-processor 146 calculates a proximity threshold and a time-derivative proximity threshold corresponding to the detected field strength. The micro-processor 146 also determines a suitable electrical-contact threshold indicative of actual electrical contact. The electrical-contact threshold can be less than the expected voltage on the user's body from contacting the power circuit 106, but preferably is greater than the coupled voltage from the power circuit 106 or other electric field sources. Other techniques can be used to determine the proximity threshold and/or the electrical-contact threshold. For example, the detector unit 102 can be provided with an input device (e.g., an input key pad) that allows the user to set the values of the thresholds.

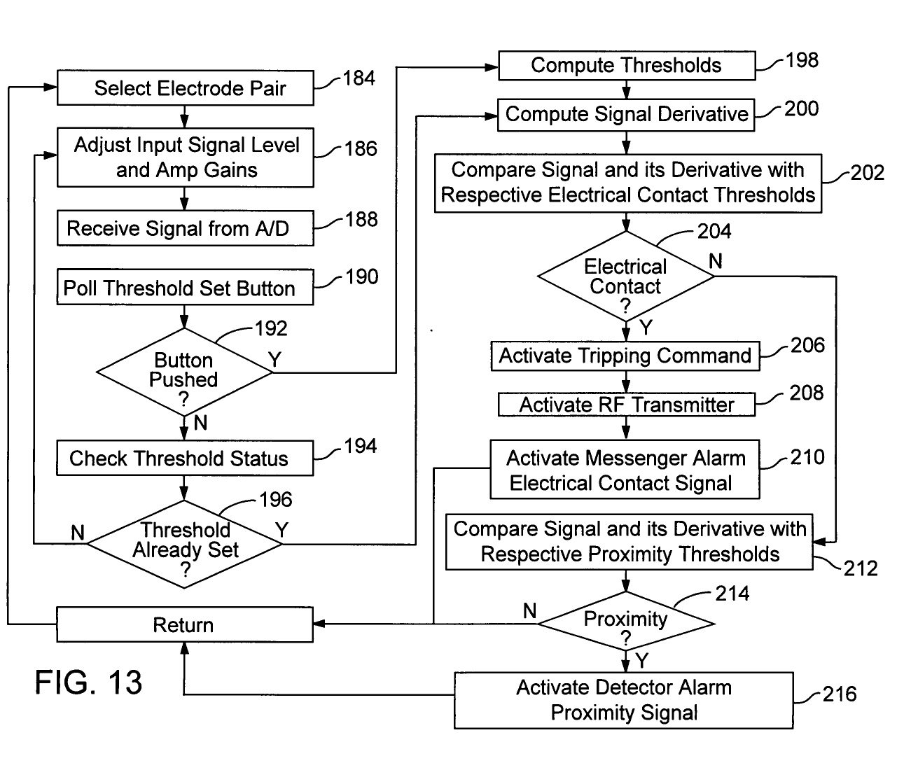

FIG. 13 is a flowchart showing the operation of the detector unit 102, according to one specific approach. In use, the micro-processor 146 controls the multiplexer 132 to select an electrode pair (as shown at block 184) and provide an output signal to the input signal level control 134. The signal is then processed by the input signal level control 134, the preamplifier 136, the filter 138, the amplifier 140, and is digitized by the A-D converter 144 (as indicated at blocks 186 and 188).

At blocks 190 and 192, the micro-processor 146 determines whether the calibration button 150 is being pressed. If the button 150 is being pressed, the micro-processor 146 calculates the proximity threshold, the time-derivative proximity threshold, the electrical-contact threshold, and the time-derivative electrical-contact threshold (as indicated at block 198). If the button 150 is not being pressed, the micro-processor 146 determines whether the thresholds have been already set (as indicated at blocks 194 and 196). If the thresholds are set, the micro-processor 146 calculates the time derivative of the digitized voltage signal (as indicated at block 200).

The micro-processor then compares the signal and its time derivative to the electrical-contact threshold and the time-derivative electrical contact threshold (as indicated at block 202) to determine whether there is an electrical contact between the power circuit 106 and the user (as indicated at block 204). If either value exceeds its respective electrical-contact threshold, indicating that an electrical contact has occurred, the micro-processor sends a tripping command to the RF transmitter to generate and transmit a tripping signal to the controller 104 (as indicated at blocks 206 and 208) and activates the alarm mechanism 124 (as indicated at block 210).

If at block 204 the voltage signal and its time derivative are less than their respective thresholds, indicating that there is no electrical contact between the user and the power circuit, the micro-processor 146 compares the voltage signal and its time derivative to the proximity threshold and the time-derivative proximity threshold (as indicated at block 212). If at block 214 either the voltage signal or its time derivative exceeds its respective proximity threshold, the alarm mechanism 124 is activated to warn the user of a close approach to the power circuit (as indicated at block 216). If both the voltage signal and its time derivative are less than their respective proximity thresholds, the program returns to block 184 where the micro-processor selects another electrode pair.

As shown in FIG. 10, the detector unit 108 includes first and second parallel electrode plates 154 and 156, respectively. The first electrode plate 154 is mounted on the metal surface of the ladder 110 (or other electrically conductive equipment) so that the entire metal surface of the ladder effectively becomes an electric field probe. The second electrode plate 156 is spaced from the first electrode plate 154 and optionally can be electrically connected to the ground to increase the sensitivity of the detector unit to sense the radiated electric field. The ladder 110 desirably is insulated from the ground, such as by placing rubber shoes 158 at the bottom of the ladder. Insulating the ladder from the ground reduces electric field leakage from the metal surface to the ground, and hence increases the sensitivity of the detector unit to sense the radiated electric field.

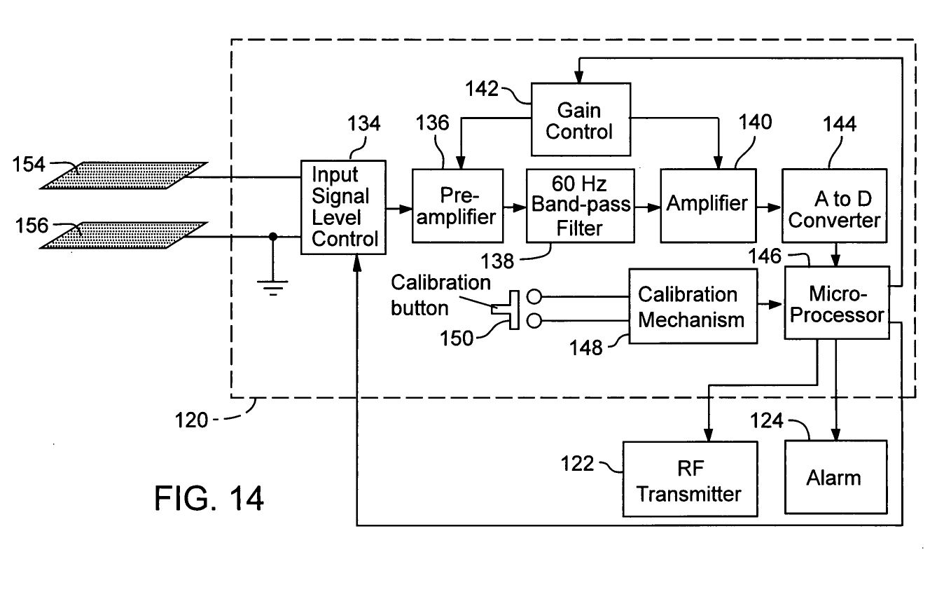

As shown in FIG. 14, the detector unit 108, like the detector unit 102, includes a field sensor 120, an alarm mechanism 124, and an RF transmitter 122. The field sensor 120 of the detector unit 108 has the same configuration as the field sensor 120 of the detector unit 102, except that the multiplexer 132 is not required. For brevity and clarity, a description of those parts which are identical or similar to those described in connection with the embodiment shown in FIG. 12 will not be repeated here.

Like the detector unit 102, the detector unit 108 can be used to detect an induced voltage between the electrode plates 154, 156, provide proximity and/or warning signals to the user, and activate the tripping mechanism 130 of the controller 104 if the user contacts the power circuit 106. The operation of the detector unit 108 is similar to that of the detector unit 102. For example, in particular embodiments, the detector unit 108 can be configured to operate in the manner shown in FIG. 13, except that a voltage is detected between only one pair of electrodes. A significant advantage of the detector unit 108 is that the entire conductive surface of the equipment on which the detector is mounted becomes an electric field probe. Thus, the detector unit 108 provides a proximity warning if any portion of the conductive surface moves within an unsafe distance from the power circuit.

In alternative embodiments, the detector unit 102 or the detector unit 108 can be used solely as a proximity detector without the controller 104. In the latter embodiments, the RF transmitter 122 would not be required.

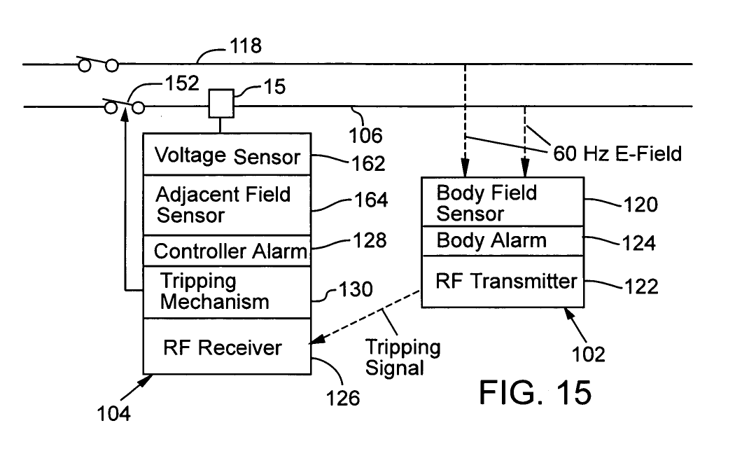

FIG. 15 shows an electrical injury protection system that is similar to the system shown in FIGS. 10 and 11, except that in the embodiment of FIG. 15, the controller 104 includes a voltage sensor 162 and an adjacent field voltage sensor 164. This embodiment can be used to monitor the “lock-out/tag-out” (LOTO) condition of a de-energized power circuit 106 and/or a de-energized adjacent power circuit. In particular, the voltage sensor 162 is operable to detect a voltage on the power circuit 106 caused by accidental re-energization of the power circuit 106. If the detected voltage exceeds a predetermined re-energization threshold, the tripping mechanism 130 is activated to de-energize the power circuit 106. Desirably, the controller 104 also activates the alarm mechanism 128 to warn personnel of the LOTO breach. The re-energization threshold can be less than the actual voltage of the power circuit 106 when energized, but preferably is greater than the coupled voltage from the adjacent power circuit 118 or other electric field sources.

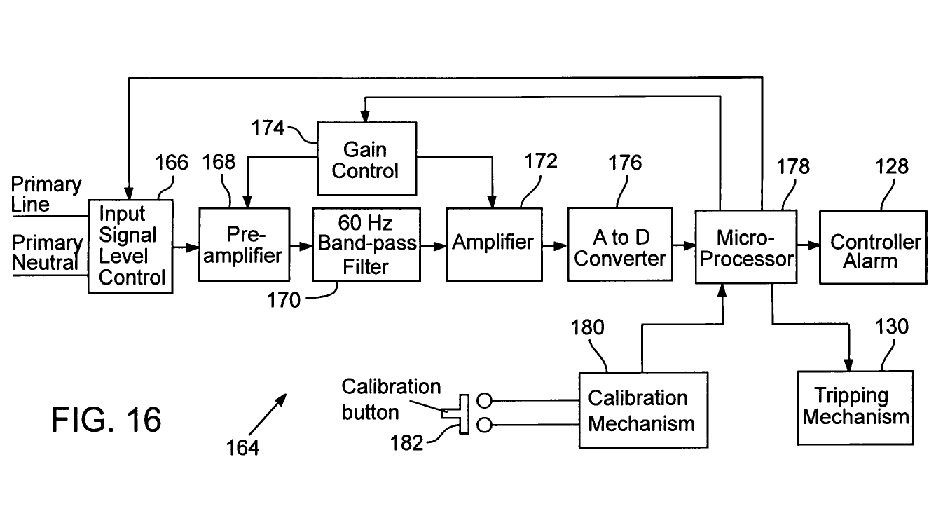

The adjacent field voltage sensor 164 senses the electric field induced on the power circuit 106 by an accidentally re-energized adjacent circuit 118 and activates the alarm mechanism 128 if the detected electric field exceeds a predetermined re-energization threshold. FIG. 16 shows a more detailed block diagram of the adjacent field voltage sensor 164, according to one embodiment. As shown in FIG. 16, the adjacent field voltage sensor 164 includes an input signal level control 166 (e.g., a digital potentiometer) connected to the primary and neutral circuits of the primary power circuit 106, a preamplifier 168, a band-pass filter 170, an amplifier 172, a gain control 174, an analog-to-digital (A-D) converter 176, a micro-processor 178, and a calibration mechanism 180. The micro-processor 178 in the illustrated embodiment is also used to process signals from the voltage sensor 162 to determine whether there is a breach of the LOTO condition of the power circuit 106.

The calibration mechanism 180 allows a user to set the re-energization threshold for the adjacent circuit 118. To calibrate the controller 104, the controller 104 is first plugged into the receptacle 15 or otherwise electrically connected to the power circuit 106. While the power circuit 106 is de-energized and the adjacent power circuit 118 is energized, the user depresses a calibration button 182. The calibration mechanism 180 detects the strength of the electric field on the power circuit 106 and outputs a signal to the micro-processor 178, which calculates a re-energization threshold for the adjacent circuit 118 corresponding to the strength of the electric field on the power circuit 106. After calibration, the adjacent circuit 118 is then de-energized.

The controller 104 shown in FIG. 15 can include a selector switch (not shown) to allow a user to select one of two operating modes of the controller. In the first operating mode, the controller 104 is used in combination with the detector unit 102 and/or detector unit 108 to monitor the user's proximity to the power circuit and if the user contacts the power circuit, de-energize the power circuit, as described above in regards to FIGS. 10-14. In the second operating mode, the controller 104 is used monitor the “lock-out/tag-out” (LOTO) condition of a de-energized power circuit 106 and/or a de-energized adjacent power circuit 118.

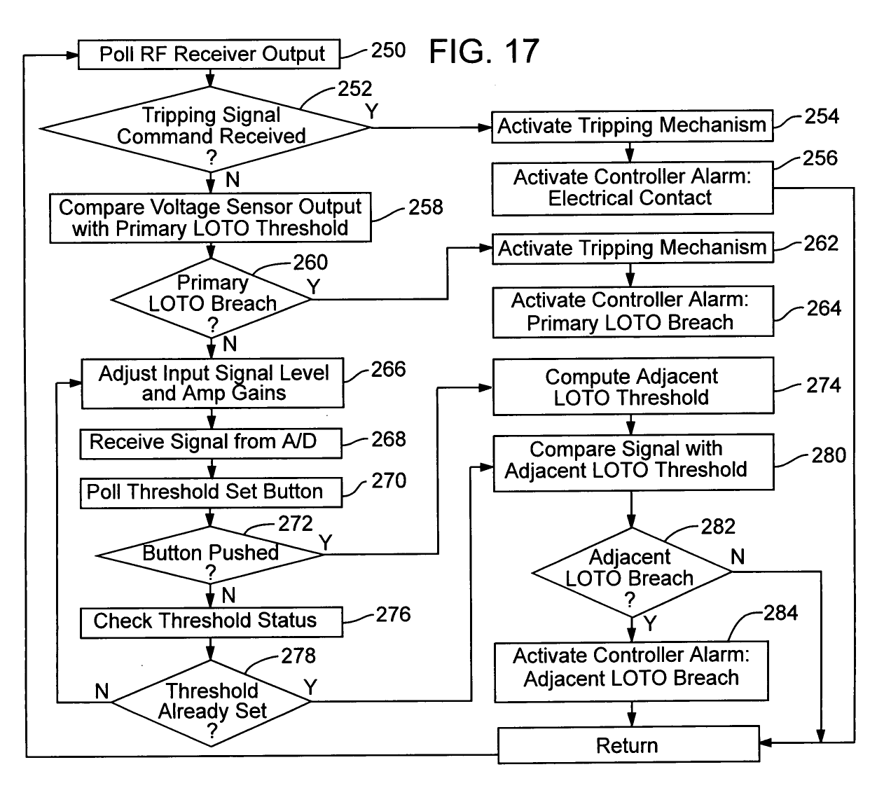

FIG. 17 is a flowchart showing the operation of the controller 104 shown in FIGS. 15 and 16, according to one specific approach. In use, the micro-processor 178 polls the RF receiver 126 (as indicated at block 250) and determines whether a tripping signal from the detector unit 102 (or the detector unit 108) has been received (as indicated by decision block 252). If the RF receiver 126 has received a tripping signal, the micro-processor 178 activates the tripping mechanism 130 and the alarm mechanism 128 (as indicated at blocks 254 and 256). If the controller is being used in the first operating mode (i.e., as a proximity and electrical-contact monitor), the operating program returns to block 250 to continuously monitor the RF receiver 126. On the other hand, if the controller is being used in the second operating mode (i.e., as a re-energization monitor), the micro-processor 178 compares the output from the voltage sensor 162 to a predetermined re-energization threshold for the primary power circuit 106 (as indicated at block 258) to determine whether there is a breach of the LOTO condition of the primary power circuit 106 (i.e., the primary power circuit has been re-energized) (as indicated at decision block 260).

If there is a breach of the LOTO condition of the primary power circuit 106, the micro-processor 178 activates the tripping mechanism 130 and the alarm mechanism 128 (as indicated at blocks 262 and 264). If there is no breach of the LOTO condition of the primary power circuit 106, the micro-processor 178 controls the input signal level control 166 of the adjacent field sensor 164 to adjust the input signal from the power circuit 106. The input signal is further processed by the preamplifier 168, the filter 170, and the amplifier 172, digitized by the A-D converter 176, and outputted to the micro-processor (as indicated at blocks 266 and 268). The micro-processor 178 then determines whether the calibration button 182 is being pressed (as indicated at blocks 270 and 272).

If the calibration button 182 is depressed, the micro-processor 178 calculates a LOTO threshold for the adjacent circuit 118 equal to or greater than the strength of the electric field detected on the power circuit 106 (as indicated at 274). If the calibration button is not depressed, the micro-processor 178 determines whether the re-energization threshold for the adjacent circuit has been set (as indicated at 276 and 278). If this threshold is set, the micro-processor 178 compares the digitized voltage signal to the threshold (as indicated at block 280) to determine whether there is a breach of the LOTO condition of the adjacent circuit (as indicated at decision block 282). If the voltage signal exceeds the re-energization threshold for the adjacent power circuit, the micro-processor 178 activates the alarm mechanism 128 (as indicated at block 284) to warn personnel of the condition. If the re-energization threshold has not been set, the micro-processor 178 adjusts the signal level and amplifier gains (as indicated at block 266).

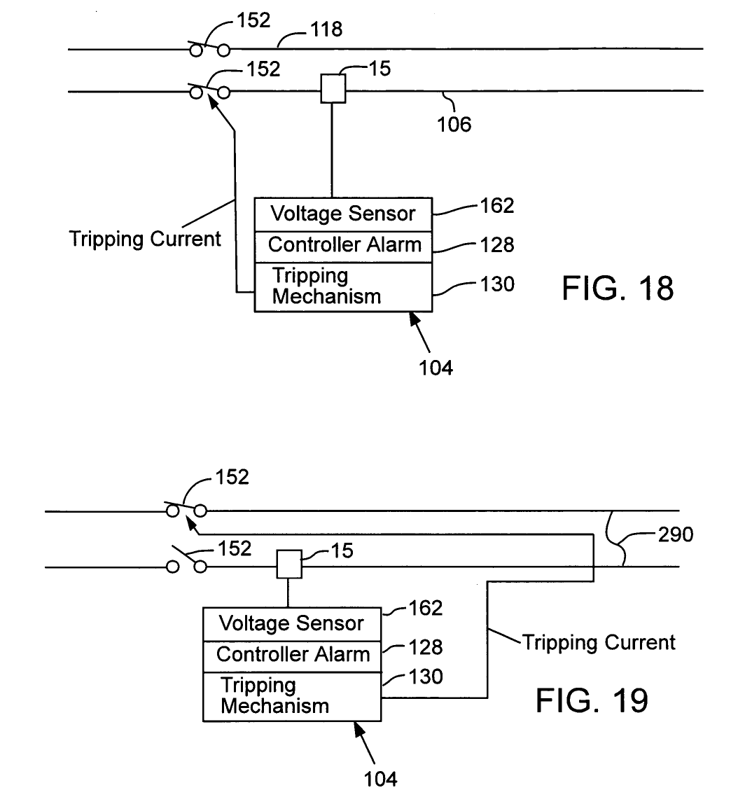

FIG. 18 shows another embodiment of the electrical injury protection system. The system of FIG. 18 includes a controller 104 that is connected to a power circuit 106, such as via an electrical outlet 15. The controller 104 in this embodiment includes an alarm mechanism 128, a tripping mechanism 130, and a voltage sensor 162. The system shown in FIG. 18 can be used to monitor the LOTO condition of the power circuit 106 and de-energize the power circuit in the event of accidental re-energization, as described above in regards to the embodiment shown in FIGS. 15-17. As shown, the controller 104 need not be used with the detector unit 102 or the detector unit 108 (FIG. 10).

FIG. 19 illustrates the use of the controller 104 to protect against injury caused by an accidentally re-energized adjacent power circuit 118 that contacts the primary power circuit 106. For example, if the adjacent power circuit 118 is accidentally re-energized and contacts the primary power circuit 106, as indicated at 290, the voltage sensor 162 detects the voltage on the power circuit 106 and activates the tripping mechanism 130 and the alarm mechanism 128. Since the circuit breaker 152 and/or GFCI on the power circuit 106 are open in a LOTO condition, activation of the tripping mechanism 130 generates an artificial overcurrent and/or ground current that trips the circuit breaker 152 and/or the GFCI on the adjacent power circuit 118.

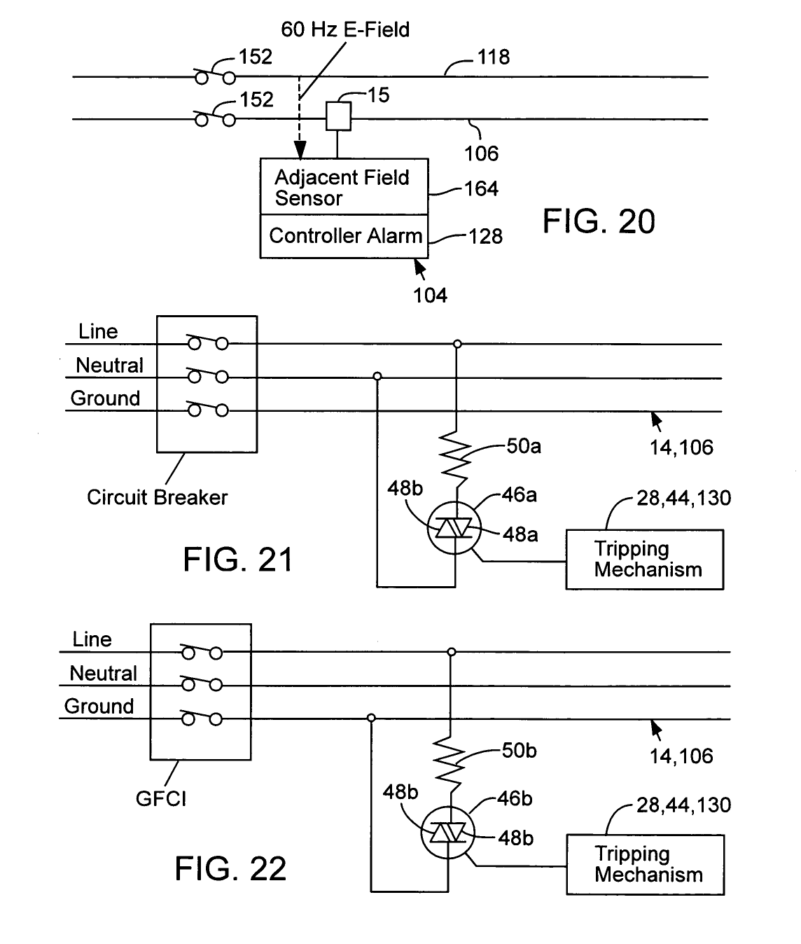

FIG. 20 shows another embodiment of the electrical injury protection system. The system of FIG. 20 includes a controller 104 that is connected to a power circuit 106, such as via an electrical outlet 15. The controller 104 in this embodiment includes an alarm mechanism 128 and an adjacent field voltage sensor 164. The system shown in FIG. 20 can be used to monitor the LOTO condition of an adjacent power circuit 118 and provide a warning signal in the event of accidental re-energization of the adjacent power circuit 118, as described above in regards to the embodiment shown in FIGS. 15-17. As shown, the controller 104 need not be used with the detector unit 102 or the detector unit 108 (FIG. 10).

The following examples are intended to further illustrate the invention and not to limit it.

### EXAMPLE 1

To demonstrate the feasibility of the electrical injury protection system, the RF transmission loss between a human body and a simulated power circuit was determined. A system comprised an RF signal generator, a pair of conductive straps bound to a human subject's right wrist 10 cm apart, a 50-m AWG 12 simulated power circuit cable, and a spectrum analyzer with its input connected to the power circuit cable. An RF signal with an amplitude of 2 volts and a sweeping frequency from 98.8 kHz to 40.6 MHz was transmitted from the signal generator to the pair of conductive straps bound on the subject's right wrist through a coaxial cable with grounded shielding. The RF signal was transmitted via the subject's body into the air. The subject first laid his/her right hand on the power circuit line without insulation, and the spectrum analyzer, which was connected to the power circuit cable, measured the transmission loss at all sweeping frequency points. The subject then laid his/her right hand on the power circuit insulation, and the spectrum analyzer re-measured transmission loss. Thereafter, the subject distanced his/her hand from the cable in small increments (2 cm, 6 cm, 10 cm, 20 cm, 40 cm, and 100 cm from the cable). The spectrum analyzer repeated the measurement at each distance from the cable.

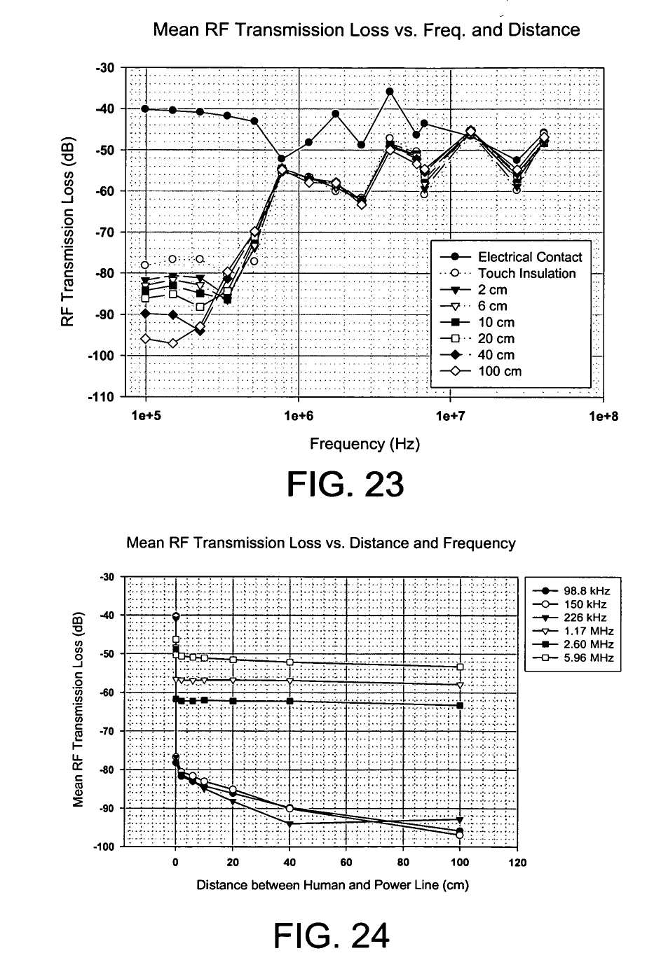

The RF transmission loss measurements were conducted on nine human subjects. RF transmission loss data were plotted versus frequency at various distances between the subject's hand and the cable in FIG. 23. The same data was also plotted in FIG. 24 for selected frequencies. The results in FIGS. 23 and 24 show that under the measurement conditions, the optimal frequency range is between 98 and 200 kHz (see FIG. 23). At 150 kHz, the RF transmission loss monotonically increased from −41 dB as a subject's hand touched the power circuit core to −76 dB as the subject's hand touched the power circuit insulation, and to −97 dB as the subject's hand moved from the power circuit insulation to a location spaced 100 cm from the power circuit insulation. As the RF further increased beyond 200 kHz, because of the increased RF radiation, the dynamic range of RF transmission loss versus distance became much narrower, and the transmission loss curve was not necessarily monotonic. At 5.9 MHz, the transmission loss curve is barely monotonic. But at these higher frequencies, such as 5.9 MHz, the transmission pattern is complex and varies drastically under slightly different test conditions, due to RF radiation and RF standing waves on the power circuit. Thus, it is better to select lower frequencies as the optimal frequency range in order to obtain a more stable RF transmission pattern. This transmission loss pattern would be up-shifted several hundred kHz along the frequency axis if the signal generator output is changed from the present grounded unbalanced output to an un-grounded balanced output.

### EXAMPLE 2

An ASK RF receiver (such as shown in FIG. 7) was used to receive, demodulate and digitize ASK RF signals transmitted from a power circuit. The receiver had a digital demodulator comprising a model AS3931 programmable low-frequency ASK wakeup receiver from Austriamicrosystems (Austria), which has a current consumption of about 9 micro-amperes under typical working conditions.

The receiver's carrier frequency was selected to be 141.6 kHz. The results of human subject tests on RF transmission between a human body and an electrical power circuit indicate that the radio frequencies between 100 and 200 kHz are optimal for human proximity detection. In this frequency range, the RF transmission insertion loss between a human body and a power circuit monotonously increases with the greatest loss gradient as the human body moves away from the power circuit.

The receiver had a saw-tooth envelope converter comprising an LC filter with a primary coil and a secondary coil for impedance inversion. The quality factor of the primary coil was about 72. The bandwidth (BW) of the filter was calculated to be about 2 kHz at the carrier frequency of 141.6 kHz using the following equation:
BW=f₀/Q.

Simulated ASK RF signals modulated by square waves were generated by an Agilent E4221 signal generator with the carrier frequency of 141.6 kHz. The frequency of the modulated square waves was 1.0 kHz. The pulse width was selected to be 52 μS in order to obtain a saw-tooth like waveform as the ASK signals are passed through an envelope converter of the receiver.

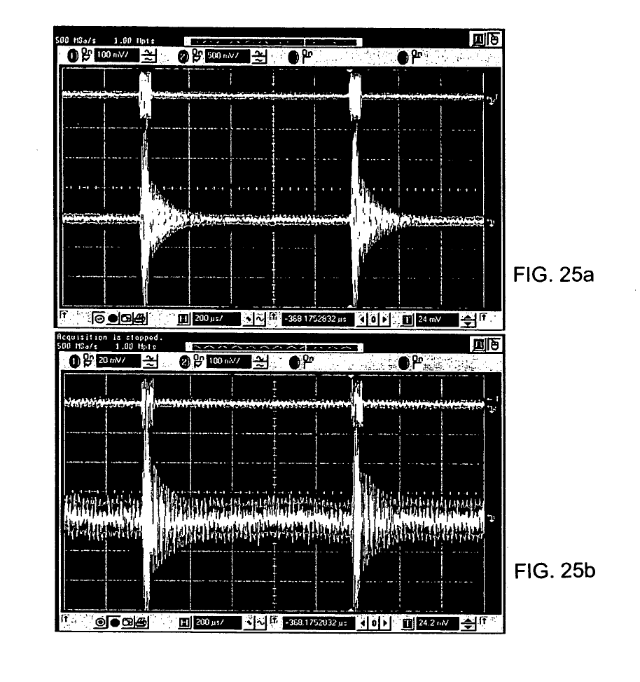

As the simulated ASK RF signal passed through the envelope converter, the ASK envelopes were converted from square waves to saw-tooth like envelopes, as shown in FIGS. 25a and 25b. FIG. 25a shows a converted ASK waveform of a 150-mV input signal. The oscilloscope amplitude (vertical) scale was tuned to 500 mV per division, so that the converted envelopes are visible on the oscilloscope. The input amplitude of the waveform in FIG. 25b (30 mV) is five times smaller than that in FIG. 25a. (Since the vertical scale of the oscilloscope in FIG. 25b is tuned such that it is five times more sensitive than that in FIG. 25a, the amplitude of the signals in FIG. 25b look similar to that in FIG. 25a.)

As shown, the proportion of the device noise floor to the amplitude of the saw-tooth-like envelopes is greater in FIG. 25b than that in FIG. 25a. This proportion increased as the amplitude of the input ASK signals decreased. This variable noise floor proportion enables the demodulator to digitize the demodulated saw-tooth-like envelopes with variable pulse widths. Since the demodulator used in this example employs an adaptive slicing threshold to digitize analog envelopes, its slicing threshold level is variable. The slicing threshold in the demodulator is determined by the average of the input envelope amplitude. With the higher noise-floor proportion in smaller amplitude input signals than that in greater amplitude input signals, the adaptive slicing threshold derived from smaller amplitude input signals mixed with the device noise is closer to the peak of the demodulated envelope than that derived for greater amplitude input signals mixed with the device noise. This device-noise modified slicing threshold ensures that the demodulator can digitize the saw-tooth-like envelopes to square waves with their pulse width directly related to the input ASK signal amplitude.

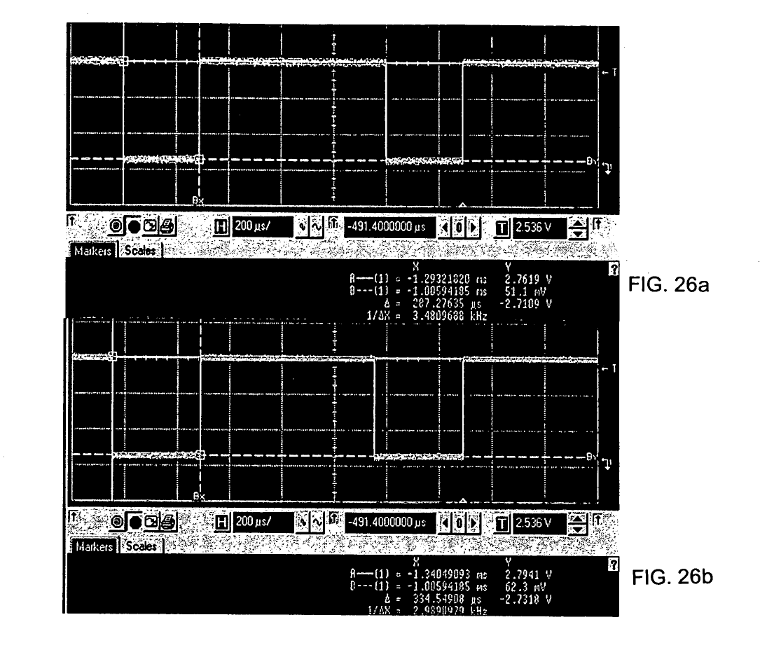

FIGS. 26a and 26b show the digitized square waves having pulse widths directly related to the magnitude of the input ASK RF waves. The amplitude of the input ASK RF signal in FIG. 26a (50 μV) is smaller than the amplitude of the input ASK RF signal in FIG. 26b (500 μV). Consequently, the (negative) pulse width of the demodulated square waves in FIG. 26a (287.3 μS) is smaller than the pulse width in FIG. 26b (334.5 μS). The pulse width difference is 47.3 μS.

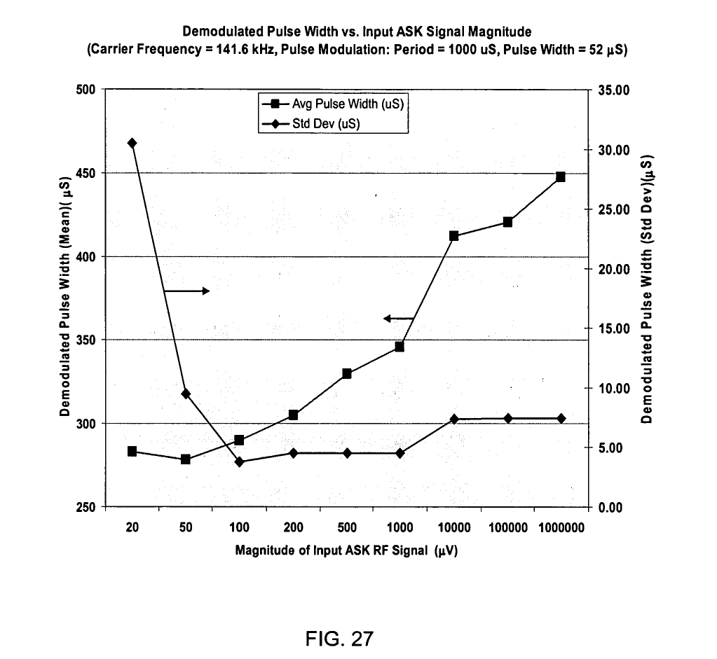

The pulse width of the digitally demodulated ASK RF signals versus the amplitude of their RF inputs in the range between 20 μV to 1 V is shown in FIG. 27. The demodulated pulse width versus the input ASK signal magnitude curve shows that the demodulated pulse width monotonically narrows as the magnitude of input ASK singal decreases, except at an input ASK signal level of 20 μV. An increase in the demodulated pulse width can be seen at about 20 μV, which can be attributed to the effect of the increased proportion of noise-floor to the input ASK amplitude. The addition of a low-noise preamplifier in front of the envelope converter could be used to increase signal-to-noise ratio and receiver sensitivity, and hence increase the human proximity detection range. Table 1 below shows the input ASK voltage versus the equivalent human proximity to a power circuit. The ASK demodulation method in this example consumed only about 9 micro-amperes of current (excluding the micro-processor current consumption), which is 1600 times less than the current consumption in a conventional demodulation method (also excluding the micro-processor current consumption).

TABLE 1

| | Input Volts (μV) | | | |
|---|---|---|---|---|
| | 3000 | 1000 | 100 | 50 |
| Equivalent | Electrical | Contact | About 2 cm | About 5 to |
| Proximity | contact | circuit | from circuit | 25 cm from |
| | | insulation | | circuit |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. An electrical injury protection system comprising:
at least three electrodes that are configured to be mounted on a user's body for detecting an electric field induced on the body by a power circuit;
a processor operatively connected to the electrodes, the processor being operable to determine a voltage between each pair of electrodes; and
an alarm mechanism that is activated if the voltage between at least one of the electrode pairs is greater than a predetermined proximity threshold to warn the user of a close approach to the power circuit.

2. The electrical injury protection system of claim 1, wherein the at least three electrodes comprises six electrodes.

3. The electrical injury protection system of claim 1, wherein the at least three electrodes are supported on a mounting device that is adapted to be worn on an extremity of the user.

4. The electrical injury protection system of claim 1, wherein the at least three electrodes are adapted to be mounted on one arm of the user.

5. The electrical injury protection system of claim 1, wherein the processor and the alarm mechanism comprise a detector unit that is adapted to be mounted on or carried by the user.

6. The electrical injury protection system of claim 1, further comprising:
a signal generator operatively connected to the processor, the signal generator being operable to generate a tripping signal if the voltage between at least one of the electrode pairs is greater than a predetermined electrical-contact threshold; and
a controller that is adapted to be electrically connected to the power circuit, the controller comprising a signal receiver and a tripping mechanism that is activated to de-energize the power circuit when the receiver receives the tripping signal from the signal generator.

7. The electrical injury protection system of claim 6, wherein the controller is adapted to be electrically connected to the power circuit via an electrical outlet on the power circuit.

8. The electrical injury protection system of claim 6, wherein the tripping mechanism is operable to de-energize the power circuit by causing an artificial lint-to-ground current to trip a ground fault circuit interrupter on the power circuit.

9. The electrical injury protection system of claim 6, wherein the tripping mechanism is operable to de-energize the power circuit by causing an artificial line-to-neutral overcurrent to trip a circuit breaker on the power circuit.

10. The electrical injury protection system of claim 6, wherein the controller further comprises an alarm mechanism that is activated when the receiver receives the tripping signal from the signal generator.

11. The electrical injury protection system of claim 6, wherein the tripping signal is transmitted from the signal generator to the signal receiver via a wireless communication link.

12. The electrical injury protection system of claim 11, wherein the tripping signal is an RF signal in the range about 902 to about 918 MHz.

13. The electrical injury protection system of claim 6, wherein the controller further comprises a re-energization voltage sensor that is operable to detect the voltage of the power circuit, and the controller is operable to activate the tripping mechanism to de-energize the power circuit if the power circuit is accidentally re-energized from a de-energized state.

14. The electrical injury protection system of claim 6, wherein the controller further comprises an adjacent field voltage sensor that is operable to detect a voltage induced on the power circuit by another, adjacent power circuit, the controller also comprising an alarm mechanism, the controller being operable to activate the alarm mechanism of the controller if the voltage induced by the adjacent power circuit is greater than a predetermined threshold.

15. An electrical injury protection system for use by a user working near a power circuit, the system comprising:
an RF signal generator adapted to be electrically connected to the power circuit, the RF signal generator being operable to generate and transmit an RF signal via the power circuit; and
a receiving unit adapted to be mounted to or carried by the user, the receiving unit comprising an alarm mechanism and being operable to receive the RF signal and activate the alarm mechanism if the RF signal exceeds a predetermined proximity threshold to warn the user of a close approach to the power circuit.

16. The electrical injury protection system of claim 15, further comprising:
a tripping mechanism adapted to be electrically connected to the power circuit; and
wherein the receiving unit is operable to transmit a tripping signal to the tripping mechanism to de-energize the power circuit if there is electrical contact between the user and the power circuit.

17. The electrical injury protection system of claim 16, wherein the tripping signal is transmitted from the receiving unit to the tripping mechanism via a wireless communication link.

18. The electrical injury protection system of claim 17, wherein the tripping signal is an RF signal.

19. The electrical injury protection system of claim 15, wherein the receiving unit comprises at least two electrodes for mounting on the user's body such that the body acts as an antenna for receiving the RF signal from the signal generator.

20. The electrical injury protection system of claim 16, wherein the RF signal generator and the tripping mechanism comprise a controller that is adapted to be electrically connected to the power circuit via an electrical outlet on the power circuit.

21. An electrical injury protection system comprising:
a detector device configured to detect a voltage induced on a user's body or on electrically conductive equipment by an electric field of a power circuit, the detector device comprising an alarm mechanism that is activated if the detected voltage exceeds a predetermined proximity threshold to warn the user of a close approach to the power circuit, the detector being operable to generate a tripping signal if the detected voltage exceeds a predetermined electrical-contact threshold; and
a controller that is adapted to be electrically connected to the power circuit, the controller comprising a signal receiver and a tripping mechanism that is activated to de-energize the power circuit when the receiver receives the tripping signal from the detector device.

22. The electrical injury protection system of claim 21, wherein the detector device further comprises:
at least three electrodes that are configured to be mounted on the user's body; and
a processor operatively connected to the electrodes, the processor being operable to determine a voltage between each pair of electrodes;
wherein the alarm mechanism is activated if the voltage between any of the electrode pairs exceeds the predetermined proximity threshold.

23. The electrical injury protection system of claim 21, wherein the alarm mechanism is operable to produce a first warning signal whenever the detected voltage exceeds the predetermined proximity threshold and a second warning signal, different than the first warning signal, whenever the detected voltage exceeds the predetermined electrical-contact threshold.

24. The electrical injury protection system of claim 21, wherein the detector device determines the time-derivative of the detected voltage and activates the alarm mechanism if the detected voltage exceeds the predetermined proximity threshold or if the time-derivative of the detected voltage exceeds a predetermined time-derivative proximity threshold.

25. The electrical injury protection system of claim 21, wherein the detector device determines the time-derivative of the detected voltage and activates the alarm mechanism if the detected voltage exceeds a predetermined electrical-contact threshold or if the time-derivative of the detected voltage exceeds the predetermined time-derivative electrical-contact threshold.

26. The electrical injury protection system of claim 21, wherein the detector device comprises:
first and second, spaced apart electrode plates, the first plate being adapted to be electrically connected to the electrically conductive equipment; and
a processor operatively connected to the electrode plates, the processor being operable to determine the voltage between the electrode plates;
wherein the alarm mechanism is activated if the voltage between the electrode plates exceeds the predetermined proximity threshold.

27. The electrical injury protection system of claim 21, wherein the detector device comprises a calibration mechanism that detects the strength of the electric field at a desired safe location spaced from the power circuit and sets the proximity threshold at a value corresponding to the strength of the detected electric field.

28. An electrical injury protection system comprising:
first and second, spaced apart electrode plates, wherein the first electrode plate is electrically connected to electrically conductive equipment that is insulated from the electric ground such that the electrically conductive equipment serves as a sensing probe for sensing an electric field of a power circuit;
a processor operatively connected to the electrode plates, the processor being operable to determine a voltage between the electrode plates induced by the radiated electric field; and
an alarm mechanism that is activated if the voltage between the electrode plates is greater than a predetermined proximity threshold to warn a user of a close approach to the power circuit.

29. The electrical injury protection system of claim 28, wherein the processor and the alarm mechanism comprise a detector unit that is mounted on the electrically conductive equipment.

30. The electrical injury protection system of claim 28, further comprising:
a signal transmitter operatively connected to the processor; and
a controller that is electrically connected to the power circuit, the controller comprising a signal receiver and a tripping mechanism for de-energizing the power circuit;
wherein when the voltage between the electrode plates exceeds a predetermined electrical-contact threshold, the signal transmitter transmits a tripping signal to the signal receiver to activate the tripping mechanism, thereby de-energizing the power circuit.

31. The electrical injury protection system of claim 30, wherein the tripping signal is transmitted from the signal transmitter to the signal receiver via a wireless communication link.

32. The electrical injury protection system of claim 28, wherein the electric field comprises a 50-60 Hz electric field.

33. An electrical injury protection system comprising:
a detector comprising at least two electrodes adapted to be mounted on a user's body for detecting a voltage on the body caused by electrical contact with a power circuit, the detector also comprising a signal transmitter for generating a wireless tripping signal if the detected voltage exceeds a predetermined electrical-contact threshold; and
a controller that is adapted to be electrically connected to the power circuit, the controller comprising a signal receiver and a tripping mechanism that is activated to de-energize the power circuit when the receiver receives the tripping signal from the signal transmitter.

34. The electrical injury protection system of claim 33, wherein the tripping mechanism is operable to trip a circuit breaker or a GFCI on the power circuit.

35. The electrical injury protection system of claim 33, wherein the signal transmitter generates an RF tripping signal.

36. An electrical injury protection system comprising:
a voltage sensor electrically connected to a power circuit and operable to detect a voltage on the power circuit generated by accidental re-energization of the power circuit; and
a tripping mechanism that is operable to de-energize the power circuit if the voltage exceeds a predetermined re-energization threshold.

37. The electrical injury protection system of claim 36, further comprising an alarm mechanism that is activated if the voltage detected by the voltage sensor exceeds the re-energization threshold.

38. The electrical injury protection system of claim 36, wherein the power circuit comprises a first power circuit, the voltage sensor comprises a first voltage sensor, the re-energization threshold comprises a first re-energization threshold, and the system further comprises:
a second voltage sensor electrically connected to the first power circuit and operable to detect a voltage induced on the first power circuit by an electric field of an accidentally re-energized second power circuit; and
an alarm mechanism that is activated if the voltage detected by the first voltage sensor exceeds the first re-energization threshold or if the voltage detected by the second voltage detector exceeds a second re-energization threshold.
